(19) United States
(12) Patent Application Publication
(10) Pub. No.: US 2013/0109572 A1
(43) Pub. Date: May 2, 2013

(54) HERBICIDAL COMPOSITIONS AND METHODS OF USE

(71) Applicants: Juliusz Pernak, Poznan (PL); Julia Shamshina, Tuscaloosa, AL (US); Praczyk Tadeusz, Lubon (PL); Anna Syguda, Czestochowa (PL); Dominika Janiszewska, Konarzewo (PL); Marcin Smiglak, Bad Friedrichshall (DE); Gabriela Gurau, Tuscaloosa, AL (US); Daniel T. Daly, Tuscaloosa, AL (US); Robin D. Rogers, Tuscaloosa, AL (US)

(72) Inventors: Juliusz Pernak, Poznan (PL); Julia Shamshina, Tuscaloosa, AL (US); Praczyk Tadeusz, Lubon (PL); Anna Syguda, Czestochowa (PL); Dominika Janiszewska, Konarzewo (PL); Marcin Smiglak, Bad Friedrichshall (DE); Gabriela Gurau, Tuscaloosa, AL (US); Daniel T. Daly, Tuscaloosa, AL (US); Robin D. Rogers, Tuscaloosa, AL (US)

(73) Assignee: The Board of Trustees of the University of Alabama, Tuscaloosa, AL (US)

(21) Appl. No.: 13/808,790

(22) PCT Filed: Jul. 6, 2011
(86) PCT No.: PCT/US11/43016

§ 371 Date: Jan. 7, 2013

Related U.S. Application Data
(60) Provisional application No. 61/361,643, filed on Jul. 6, 2010.

(51) Int. Cl. A01N 57/18

(52) U.S. Cl. CPC A01N 57/18
USPC 504/206; 546/184; 562/575; 548/579; 548/335.1; 544/110

(57) ABSTRACT

Disclosed are compositions and methods of preparing compositions of active herbicidal ingredients. Also disclosed are methods of using the compositions described herein to improve herbicide delivery and efficacy, enhance herbicidal penetration, reduce herbicide volatility and drift, diminish environmental damage from herbicides, decrease water solubility and volatility of herbicides, and introduce additional biological function to herbicides.

### CROSS REFERENCE TO RELATED APPLICATIONS

This application claims the benefit of priority to U.S. Provisional Application 61/361,643, filed Jul. 6, 2010, which is incorporated by reference herein in its entirety.

### FIELD

The subject matter disclosed herein generally relates to compositions and to methods of preparing compositions of active herbicidal ingredients. Also the subject matter disclosed herein generally relates to methods of using the compositions described herein to improve herbicide delivery and efficacy, introduce additional biological function to herbicides, enhance herbicidal penetration, reduce herbicide volatility and drift, diminish environmental damage from herbicides, and decrease water solubility of herbicides.

### BACKGROUND

An herbicide is a natural or synthetic chemical substance used to kill unwanted plants. An herbicide applied to a plant results in producing a stimulatory, inhibitory, regulatory, toxic, or lethal response in the plant. Selective herbicides kill specific targets while leaving the desired crop relatively unharmed. Some of these act by interfering with the growth of the weed and are synthetic “imitations” of naturally occurring plant hormones. Derivatives of phenoxy acids have been commercialized as herbicides since the 1940's and they are still one of the widest used herbicide chemical classes. Among these phenoxy acid derivatives are 2,4-dichlorophenoxyacetic acid (2,4-D), 4-chloro-2-methylphenoxyacetic acid (MCPA), Dicamba, Mecoprop, and Mecoprop—P. A further example of an herbicide is Glyphosate, an organophosphorus broad-spectrum herbicide with a non-selective systemic mode of action that has been commercially available since 1974.

Dicamba, also known as 3,6-dichloro-o-anisic acid or 3,6-dichloro-2-methoxy benzoic acid, is a white, crystalline substance with a melting point of 114-116° C. and is both water soluble (500 mg/dm³) and alcohol soluble (922 g/dm³ ethanol). Dicamba is a selective systemic herbicide belonging to a group of growth regulators, a naturally occurring plant hormone that causes uncontrolled growth in plants. At sufficiently high levels of exposure, the herbicide quickly moves in the plant and is accumulated mainly in areas of growth, resulting in such a severe abnormal growth that the plant dies. This herbicide is designed to control annual and perennial weeds in cereals, corn, perennial seed grasses, sugar cane, on lawns, pastures, and areas of non-agricultural use. Dicamba is most effective on weeds that are in early stages of development. Dicamba can be used as a single active substance (commercial preparations such as Dicamba 480 SL or Banvel 480 SL), or in a mixture with other compounds such as 2,4-D, MCPA, mecoprop, prosulfuron, triasulfuron, and primisulfuron-methyl.

Weeds that are sensitive to Dicamba include plantain (Plantago spp.), geranium tiny, white pigweed (Amaranthus albus), redroot pigweed (Amaranthus retroflexus), Chamomile (Matricaria recutita), and Sheperd's-purse (Capsella bursa-pastoris). Weeds that are of medium sensitivity to Dicamba include Field Violet (Viola arvensis), Purple Deadnettle (Lamium purpureum), dandelion (Taraxacum officinale), Canada thistle (Cirsium arvense), field bindweed (Convolvulus arvensis), corn speedwell (Veronica arvensis), cleavers (Galium aparine), and spurge species (Euphorbia spp).

Mecoprop, also known under the abbreviated name of MCPP [(R, S)-2-(4-chloro-o-tolyloxy)propionic acid or (±)-2-(4-chloro-2-methylphenoxy)propionic acid], and Mecoprop-P, also known under the abbreviated name of MCPP-P [(R)-2-(4-chloro-o-tolyloxy)propionic acid] or [(+)-(R)-2-(4-chloro-2-methylphenoxy)propionic acid], are also derivatives of phenoxycarboxylic acid. These compounds are similar to Dicamba in mechanism of action, as selective systemic growth regulators. They are mainly used for post-emergence control of annual and perennial broadleaf weeds, mainly in cereals, rice, orchards, grasslands, and on non-crop land.

Glyphosate is N-(phosphonomethyl)glycine, a non-selective systemic herbicide used to kill a broad-spectrum of weeds. It is typically sprayed and absorbed through the leaves or applied to the stump of a tree, or broadcast or used in the cut-stump treatment as a forestry herbicide. Glyphosate is the most used herbicide in the USA where 85-90 million pounds are used annually in US agriculture. Glyphosate's mode of action is to inhibit an enzyme involved in the synthesis of the aromatic amino acids tyrosine, tryptophan, and phenylalanine It is absorbed through foliage and translocated to growing points. Because of its mode of action, it is effective on actively growing plants.

None of the aforementioned herbicides bind to soil particles, and therefore have high potential to leach from soils, and the leaching increases when higher amounts of herbicide are applied. Additionally, all four herbicides are highly water soluble and persist in groundwater, resulting in restricted use by the Environmental Protection Agency since 1987. Thus, these herbicides are able to move from the intended target onto non-target crops (i.e., off-target movement) through (i) drift by physical movement of spray, (ii) volatilization by evaporation of the applied herbicide, and (iii) lateral movement by ground water. Because of the wide agricultural and environmental importance, there is increasing interest in finding derivatives of these herbicides that will maintain or improve the herbicidal properties while eliminating mobility issues and increasing efficacy to result in lower overall chemical usage.

Dicamba, Glyphosate, Mecoprop, and Mecoprop-P may volatilize from plant surfaces, especially when temperatures are over 30° C., due to high vapor pressure. Under normal conditions, the herbicidal vapors can drift up to 5-10 miles thereby contaminating and injuring off-target vegetation severely. Further, crop production areas are often close to urban environments and such “off-target” movement of herbicides is environmentally harmful. Additionally, the acidic herbicides are highly toxic, which poses significant hazards to a worker's safety and surroundings. For example, rat LD₅₀ ranges for 2.4-D, MCPA, MCPP, and Dicamba are 639-764, 962-1470, 431-1050, and 1039 mg/kg, respectively.

Minimization of off-target movement of applied herbicides should be achieved to (i) reduce environmental impact, (ii) diminish potential for human contamination including workers, and (iii) lessen the potential economic losses due to movement onto non-desirable crops. Excessive leaching and vaporization affect herbicidal efficacy; thus, several forms of these compounds, e.g., chemically modified structures such as emulsified esters, dimethylamine salts, and metal salts, have been developed and used to prolong activity and minimize leaching. In terms of the required dose, the emulsified esters are among the most efficient in controlling harmful undergrowth; however, these derivatives suffer from issues similar to non-modified herbicides, including drifting and volatility. Interestingly, some dimethylamine and methylamine salts are more efficient; however, upon volatilization of these low boiling amines, the compounds revert to the original neutral, volatile parent herbicide. Potassium and sodium salts are less volatile, but are unfortunately highly water soluble and persist in ground water. Adjustment of the acidity of herbicidal formulations (i.e., increasing and decreasing the acidity) has also been attempted; however, no effect was observed on movement in the soil. Additionally, increased persistence was observed when the pH increased from 5.3 to 7.5. Use of additives or adjuvants to decrease the mobility issues has only been partially successful. Further, due to the presence of a carboxylic acid group, the herbicides can form complexes with metal ions and, thereby, increase their mobility in the environment.

In order to overcome the issues outlined above, the subject matter disclosed herein relates to herbicides that possess reduced volatility and drift and demonstrate lower water solubility. The disclosed subject matters also relates to herbicides that can stay on the plant longer, thus reducing repeat applications and environmental mobility and increasing worker safety. Derivatization of current herbicides as described herein can allow for two biologically independent actives to be chosen, therefore a specific functionality or property can independently and simultaneously be introduced. Methods of preparing these compositions are also needed and described herein. As such, the compositions and methods described herein meet these and other needs, including introducing additional biological functionality and reducing the number of required additional agents for application.

### SUMMARY

In accordance with the purposes of the disclosed materials, compounds, compositions, devices, and methods, as embodied and broadly described herein, the disclosed subject matter, in one aspect, relates to compounds and compositions and methods for preparing and using such compounds and compositions. In a further aspect, the disclosed subject matter relates to compositions that can be used for or in industrial and commercial herbicidal compositions. Methods for making the disclosed compositions are also disclosed. Also disclosed are methods of preparing compositions of active herbicidal ingredients. Further disclosed are methods of using the compositions described herein improve herbicide efficacy, reduce herbicide volatility and drift, and diminish environmental damage.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying Figures, which are incorporated in and constitute a part of this specification, illustrate several aspects described below.

FIG. 1 is a group of pictures of Mecoprop-P treated and untreated common lambsquarters plants. FIGS. 1A and 1B are pictures of plants treated with Mecoprop-P—contained ionic liquid formulations. FIG. 1C is a picture of plants treated with commercially available Mecoprop-P, as a single compound. FIG. 1D is a picture of the untreated plants.

FIG. 2 is a group of pictures of Glyphosate treated and untreated common poppy plants. FIG. 2A is a picture of, from left to right, 1) the untreated plants, 2) plants treated with first Glyphosate-containing ionic liquid formulation, 3) plants treated with second Glyphosate-containing ionic liquid formulation, and 4) plants treated with commercially available Glyphosate (Roundup 360 SL; Monsanto Company, St. Louis, Mo.), not modified. FIG. 2B is a picture of, from left to right, 1) the untreated plants, 2) plants treated with Glyphosate as an anion in a third ionic liquid formulation, 3) plants treated with Glyphosate as an anion in a fourth ionic liquid formulation, and 4) plants treated with commercially available Glyphosate (Roundup 360 SL; Monsanto Company, St. Louis, Mo.).

### DETAILED DESCRIPTION

Provided herein are compositions that include herbicides, including but not limited to Dicamba, Glyphosate, Mecoprop, and Mecoprop-P as anions. The herbicidal compositions described herein contain cations and anions and possess dual functionality in which both the cation and anion contribute different properties such as biological activity and physical properties to the composition. For example, the herbicidal compositions are designed to improve delivery of the herbicides and introduce additional biological function (e.g., antimicrobial, fungicidal, and other herbicidal) to the herbicides. Penetration enhancers, such as surfactants and fatty acids, are also introduced into the herbicidal compositions to provide increased penetration into the plant, which results in increased efficacy.

The anions and cations of the disclosed compositions can result in an ionic liquid. As such, the disclosed compositions in some aspects can be ionic liquids and can be used in that form. However, ionic liquids need not actually be prepared and used. Thus, in other aspects, a composition where cations and anions, which together are capable of forming an ionic liquid, are dissolved in a solution. While not wishing to be bound by theory, it is believed that as a result of the ionic liquid forming propensity of the particular cations and anions used, the herbicidal compositions described herein can possess reduced volatility and drift, which will increased worker safety, and demonstrate lower water solubility. Thus, the herbicidal compositions can remain on the plant for a longer period, reducing both repeat applications and environmental mobility (e.g., through water wash off or volatization into the environment). In addition, the combination of two or more active chemicals in a single composition reduces the number of additional chemicals such as adjuvants or surfactants required per application, and can introduce secondary biological function.

The materials, compounds, compositions, articles, and methods described herein can be understood more readily by reference to the following detailed description of specific aspects of the disclosed subject matter and the Examples and Figures included therein.

Before the present materials, compounds, compositions, articles, devices, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### A. General Definitions

In this specification and in the claims that follow, reference will be made to a number of terms, which shall be defined to have the following meanings

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an ionic liquid” includes mixtures of two or more such ionic liquids, reference to “the compound” includes mixtures of two or more such compounds, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed, then “less than or equal to” the value, “greater than or equal to the value,” and possible ranges between values are also disclosed, as appropriately understood by the skilled artisan. For example, if the value “10” is disclosed, then “less than or equal to 10” as well as “greater than or equal to 10” is also disclosed. It is also understood that throughout the application data are provided in a number of different formats and that this data represent endpoints and starting points and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

As used herein, by “plants” is meant terrestrial plants and aquatic plants.

By “reduce” or other forms of the word, such as “reducing” or “reduction,” is meant lowering of an event or characteristic (e.g., microorganism growth or survival). It is understood that this is typically in relation to some standard or expected value, in other words it is relative, but that it is not always necessary for the standard or relative value to be referred to. For example, “reduces plant growth” means lowering the amount of plant relative to a standard or a control.

By “prevent” or other forms of the word, such as “preventing” or “prevention,” is meant to stop a particular event or characteristic, to stabilize or delay the development or progression of a particular event or characteristic, or to minimize the chances that a particular event or characteristic will occur. Prevent does not require comparison to a control as it is typically more absolute than, for example, reduce. As used herein, something could be reduced but not prevented, but something that is reduced could also be prevented. Likewise, something could be prevented but not reduced, but something that is prevented could also be reduced. It is understood that where reduce or prevent are used, unless specifically indicated otherwise, the use of the other word is also expressly disclosed.

By “treat” or other forms of the word, such as “treated” or “treatment,” is meant to administer a composition or to perform a method in order to reduce, prevent, inhibit, break-down, or eliminate a particular characteristic or event (e.g., microorganism growth or survival).

The term “control” is used synonymously with the term “treat.”

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

### B. Chemical Definitions

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

The term “ion,” as used herein, refers to any molecule, portion of a molecule, cluster of molecules, molecular complex, moiety, or atom that contains a charge (positive, negative, or both at the same time within one molecule, cluster of molecules, molecular complex, or moiety (e.g., Zwitterions)) or that can be made to contain a charge. Methods for producing a charge in a molecule, portion of a molecule, cluster of molecules, molecular complex, moiety, or atom are disclosed herein and can be accomplished by methods known in the art, e.g., protonation, deprotonation, oxidation, reduction, alkylation acetylation, esterification, deesterification, hydrolysis, etc.

The term “anion” is a type of ion and is included within the meaning of the term “ion.” An “anion” is any molecule, portion of a molecule (e.g., Zwitterion), cluster of molecules, molecular complex, moiety, or atom that contains a net negative charge or that can be made to contain a net negative charge. The term “anion precursor” is used herein to specifically refer to a molecule that can be converted to an anion via a chemical reaction (e.g., deprotonation).

The term “cation” is a type of ion and is included within the meaning of the term “ion.” A “cation” is any molecule, portion of a molecule (e.g., Zwitterion), cluster of molecules, molecular complex, moiety, or atom, that contains a net positive charge or that can be made to contain a net positive charge. The term “cation precursor” is used herein to specifically refer to a molecule that can be converted to a cation via a chemical reaction (e.g., protonation or alkylation).

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valencies of the heteroatoms. This disclosure is not intended to be limited in any manner by the permissible substituents of organic compounds.

Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

“A¹,” “A²,” “A³,” and “A⁴” are used herein as generic symbols to represent various specific substituents. These symbols can be any substituent, not limited to those disclosed herein, and when they are defined to be certain substituents in one instance, they can, in another instance, be defined as some other substituents.

The term “aliphatic” as used herein refers to a non-aromatic hydrocarbon group and includes branched and unbranched, alkyl, alkenyl, or alkynyl groups.

The term “alkyl” as used herein is a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, nonyl, decyl, dodecyl, tetradecyl, hexadecyl, eicosyl, tetracosyl, and the like. The alkyl group can also be substituted or unsubstituted. The alkyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halide, e.g., fluorine, chlorine, bromine, or iodine. The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkyl alcohol” is used in another, it is not meant to imply that the term “alkyl” does not also refer to specific terms such as “alkyl alcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “alkoxy” as used herein is an alkyl group bound through a single, terminal ether linkage; that is, an “alkoxy” group can be defined as —OA¹ where A¹ is alkyl as defined above.

The term “alkenyl” as used herein is a hydrocarbon group of from 2 to 24 carbon atoms with a structural formula containing at least one carbon-carbon double bond. Asymmetric structures such as (A¹A²)C═C(A³A⁴) are intended to include both the E and Z isomers. This can be presumed in structural formulae herein wherein an asymmetric alkene is present, or it can be explicitly indicated by the bond symbol C═C. The alkenyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

The term “alkynyl” as used herein is a hydrocarbon group of 2 to 24 carbon atoms with a structural formula containing at least one carbon-carbon triple bond. The alkynyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

The term “aryl” as used herein is a group that contains any carbon-based aromatic group including, but not limited to, benzene, naphthalene, phenyl, biphenyl, phenoxybenzene, and the like. The term “aryl” also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term “non-heteroaryl,” which is also included in the term “aryl,” defines a group that contains an aromatic group that does not contain a heteroatom. The aryl group can be substituted or unsubstituted. The aryl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol as described herein.

The term “cycloalkenyl” as used herein is a non-aromatic carbon-based ring composed of at least three carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The term “heterocycloalkenyl” is a type of cycloalkenyl group as defined above, and is included within the meaning of the term “cycloalkenyl,” where at least one of the carbon atoms of the ring is substituted with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol as described herein.

The term “cyclic group” is used herein to refer to either aryl groups, non-aryl groups (i.e., cycloalkyl, heterocycloalkyl, cycloalkenyl, and heterocycloalkenyl groups), or both. Cyclic groups have one or more ring systems that can be substituted or unsubstituted. A cyclic group can contain one or more aryl groups, one or more non-aryl groups, or one or more aryl groups and one or more non-aryl groups.

The term “aldehyde” as used herein is represented by the formula —C(O)H. Throughout this specification “C(O)” is a short hand notation for C═O.

The terms “amine” or “amino” as used herein are represented by the formula NA¹A²A³, where A¹, A², and A³ can be, independently, hydrogen, an alkyl, halogenated alkyl, alkenyl, alkynyl, aryl, heteroaryl, cycloalkyl, cycloalkenyl, heterocycloalkyl, or heterocycloalkenyl group described above.

The term “carboxylic acid” as used herein is represented by the formula —C(O)OH. A “carboxylate” as used herein is represented by the formula —C(O)O⁻.

The term “ester” as used herein is represented by the formula —OC(O)A¹ or C(O)OA¹, where A¹ can be an alkyl, halogenated alkyl, alkenyl, alkynyl, aryl, heteroaryl, cycloalkyl, cycloalkenyl, heterocycloalkyl, or heterocycloalkenyl group described above.

The term “ether” as used herein is represented by the formula A¹OA², where A¹ and A² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “ketone” as used herein is represented by the formula A¹C(O)A², where A¹ and A² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “halide” as used herein refers to the halogens fluorine, chlorine, bromine, and iodine.

The term “hydroxyl” as used herein is represented by the formula—OH.

The term “nitro” as used herein is represented by the formula—NO₂.

The term “silyl” as used herein is represented by the formula—SiA¹A²A³, where A¹, A², and A³ can be, independently, hydrogen, alkyl, halogenated alkyl, alkoxy, alkenyl, alkynyl, aryl, heteroaryl, cycloalkyl, cycloalkenyl, heterocycloalkyl, or heterocycloalkenyl group described above.

“R¹,” “R²,” “R³,” “Rⁿ,” etc., where n is some integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an amine group, an alkyl group, a halide, and the like. Depending upon the groups that are selected, a first group can be incorporated within second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

It is to be understood that the compounds provided herein may contain chiral centers. Such chiral centers may be of either the (R—) or (S—) configuration, or may be a mixture thereof. Thus, the compounds provided herein may either be enantiomerically pure, or be diastereomeric or enantiomeric mixtures. In the case of amino acid residues, such residues may be of either the L- or D-form. The configuration for naturally occurring amino acid residues is generally L. As used herein, the term “amino acid” refers to a-amino acids which are either racemic, or of pure D- or L-configuration. The designation “d” or “D” preceding an amino acid designation (e.g., dAla, dSer, dVal, etc.) refers to the D-isomer of the amino acid. The designation “1” or “L” preceding an amino acid designation (e.g., 1Ala, 1Ser, 1Val, etc.) refers to the L-isomer of the amino acid. The designation “dl” or “DL” preceding an amino acid designation refers to a mixture of the L- and D-isomers of the amino acid. It is to be understood that the chiral centers of the compounds provided herein may undergo epimerization in vivo. As such, one of skill in the art will recognize that administration of a compound in its (R—) form is equivalent, for compounds that undergo epimerization in vivo, to administration of the compound in its (S—) form.

As used herein, substantially pure means sufficiently homogeneous to appear free of readily detectable impurities as determined by standard methods of analysis, such as thin layer chromatography (TLC), nuclear magnetic resonance (NMR), gel electrophoresis, high performance liquid chromatography (HPLC) and mass spectrometry (MS), gas-chromatography mass spectrometry (GC-MS), and similar, used by those of skill in the art to assess such purity, or sufficiently pure such that further purification would not detectably alter the physical and chemical properties, such as enzymatic and biological activities, of the substance. Both traditional and modern methods for purification of the compounds to produce substantially chemically pure compounds are known to those of skill in the art. A substantially chemically pure compound may, however, be a mixture of stereoisomers.

The term “bioactive property” is any local or systemic biological, physiological, or therapeutic effect in a biological system. For example, the bioactive property can be the control of pesticidal, herbicidal, nutritional, antimicrobial, fungicidal, an algaecidal, insecticidal, miticidal, molluscicidal, nematicidal, rodenticidal, virucidal action, penetration enhancer, etc. Many examples of these and other bioactive properties are disclosed herein.

Unless stated to the contrary, a formula with chemical bonds shown only as solid lines and not as wedges or dashed lines contemplates each possible isomer, e.g., each enantiomer, diastereomer, and meso compound, and a mixture of isomers, such as a racemic or scalemic mixture.

The term “ion pair” is a positive ion (i.e., cation) and a negative ion (i.e., anion) that are temporarily bonded together by an attractive force (i.e., electrostatic, van-der-Waals, ionic).

The term “ionic liquid” describes a salt with a melting point below 150° C., whose melt is composed of discrete ions.

The term “hydrogen bond” describes an attractive interaction between a hydrogen atom from a molecule or molecular fragment X-H in which X is more electronegative than H, and an atom or a group of atoms in the same or different molecule, in which there is evidence of bond formation. The hydrogen bond donor can be a cation and the hydrogen bond acceptor can be an anion.

The term “co-crystal” describes a crystalline structure made up of two or more atoms, ions, or molecules that exist in a definite stoichiometric ratio. Generally, a co-crystal is comprised of two or more components that are not covalently bonded and instead are bonded via van-der-Waals interactions, ionic interactions or via hydrogen bonding.

The term “complex” describes a coordination complex, which is a structure comprised of a central atom or molecule that is weakly connected to one or more surrounding atoms or molecules, or describes chelate complex, which is a coordination complex with more than one bond.

The term “eutectic” is a mixture of two or more ionic liquids, ionic liquids and neutral compounds, ionic liquids and charge compounds, ionic liquids and complexes, ionic liquids and ion pairs, or two or more ion pairs that have at least one component in common.

It is understood that throughout this specification the identifiers “first” and “second” are used solely to aid in distinguishing the various components and steps of the disclosed subject matter. The identifiers “first” and “second” and the like are not intended to imply any particular order, amount, preference, or importance to the components or steps modified by these terms.

Reference will now be made in detail to specific aspects of the disclosed materials, compounds, compositions, articles, and methods, examples of which are illustrated in the accompanying Examples.

### C. Materials and Compositions

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), Sigma (St. Louis, Mo.), Pfizer (New York, N.Y.), GlaxoSmithKline (Raleigh, N.C.), Merck (Whitehouse Station, N.J.), Johnson & Johnson (New Brunswick, N.J.), Aventis (Bridgewater, N.J.), AstraZeneca (Wilmington, Del.), Novartis (Basel, Switzerland), Wyeth (Madison, N.J.), Bristol-Myers-Squibb (New York, N.Y.), Roche (Basel, Switzerland), Lilly (Indianapolis, Ind.), Abbott (Abbott Park, Ill.), Schering Plough (Kenilworth, N.J.), Akzo Nobel Chemicals Inc (Chicago, Ill.), Degussa Corporation (Parsippany, N.J.), Monsanto Chemical Company (St. Louis, Mo.), Dow Agrosciences LLC (Indianapolis, Ind.), DuPont (Wilmington, Del.), BASF Corporation (Florham Park, N.J.), Syngenta US (Wilmington, Del.), FMC Corporation (Philadelphia, Pa.), Valent U.S.A. Corporation (Walnut Creek, Ca.), Applied Biochemists Inc (Germantown, Wis.), Rohm and Haas Company (Philadelphia, Pa.), Bayer CropScience (Research Triangle Park, N.C.), or Boehringer Ingelheim (Ingelheim, Germany), or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989). Other materials can be obtained from commercial sources.

In one aspect, disclosed herein are compositions comprising a cation and anion that form an ion pair, ionic liquid, are hydrogen bonded, form a complex, eutectic, or form a cocrystal. In a preferred aspect, the disclosed compositions are ionic liquids. The term “ionic liquid” has many definitions in the art, but is used herein to refer to salts (i.e., compositions comprising cations and anions) that are liquid at a temperature of at or below about 150° C. That is, at one or more temperature ranges or points at or below about 150° C. the disclosed ionic liquid compositions are liquid; although, it is understood that they can be solids at other temperature ranges or points. See e.g., Wasserscheid and Keim, Angew Chem Int Ed Engl, 2000, 39:3772;

and Wasserscheid, “Ionic Liquids in Synthesis,” 1^{st} Ed., Wiley-VCH, 2002. Further, exemplary properties of ionic liquids are high ionic range, non-volatility, non-flammability, high thermal stability, wide temperature for liquid phase, highly solvability, and non-coordinating. For a review of ionic liquids see, for example, Welton, Chem Rev. 1999, 99:2071-2083; and Carlin et al., Advances in Nonaqueous Chemistry, Mamantov et al. Eds., VCH Publishing, New York, 1994.

The term “liquid” describes the compositions that are generally in amorphous, non-crystalline, or semi-crystalline state. For example, while some structured association and packing of cations and anions can occur at the atomic level, an ionic liquid composition can have minor amounts of such ordered structures and are therefore not crystalline solids. The compositions can be fluid and free-flowing liquids or amorphous solids such as glasses or waxes at temperatures at or below about 150° C. In particular examples described herein, the ionic liquid compositions are liquid at the temperature at which the composition is applied (i.e., ambient temperature).

Further, the disclosed compositions are materials composed of at least two different ions, each of which can independently and simultaneously introduce a specific characteristic to the composition not easily obtainable with traditional dissolution and formulation techniques. Thus, by providing different ions and ion combinations, one can change the characteristics or properties of the disclosed compositions in a way not seen by simply preparing various crystalline salt forms.

Examples of characteristics that can be controlled in the disclosed compositions include, but are not limited to, melting, solubility control, rate of dissolution, and a biological activity or function. It is this multi-nature/functionality of the disclosed ionic liquid compositions which allows one to fine-tune or design in very specific desired material properties.

It is further understood that the disclosed compositions can include solvent molecules (e.g., water); however, these solvent molecules are not required to be present in order to form the ionic liquids. That is, the disclosed compositions can contain, at some point during preparation and application no or minimal amounts of solvent molecules that are free and not bound or associated with the ions present in the ionic liquid composition. The disclosed compositions can, after preparation, be further diluted with solvent molecules (e.g., water) to form a solution suitable for application. Thus, the disclosed compositions can be liquid hydrates, solvates, or solutions. It is understood that solutions formed by diluting ionic liquids, for example, possess enhanced chemical properties that are unique to ionic liquid-derived solutions.

The specific physical properties (e.g., melting point, viscosity, density, water solubility, etc.) of ionic liquids, eutectics, complexes, or cocrystals are determined by the choice of cation and anion, as is disclosed more fully herein. As an example, the melting point for these compositions can be changed by making structural modifications to the ions or by combining different ions. Similarly, the particular chemical properties (e.g., toxicity, bioactivity, etc.), can be selected by changing the constituent ions of the composition.

Since many ionic liquids are known for their non-volatility, thermal stability, and ranges of temperatures over which they are liquids, the numerous deficiencies of herbicides can be addressed through the formation of ionic liquids or solutions of ions that capable of forming ionic liquids from the herbicidal anion and an appropriate cation, rather than covalent modification of the active herbicidal anion itself. The compositions disclosed herein are comprised of at least one herbicidal active anion and at least one kind of cation. The at least one kind of cation can be a pesticidal active, a second herbicidal active, an antimicrobial active, a fungicidal active, an algaecide, an insecticide, a miticide, a molluscicide, a nematicide, a rodenticide, a virucide, or the like, including any combination thereof, as is disclosed herein. It is contemplated that the disclosed compositions can comprise one kind of cation with more than one herbicidal active anion (e.g., 2, 3, 4, 5, 6, 7, 8, 9, 10 or more different herbicidal anions). Likewise, it is contemplated that the disclosed compositions can comprise one herbicidal anion with more than one kind of cation (e.g., 2, 3, 4, 5, 6, 7, 8, 9, 10, or more different kinds of cations). Further, the disclosed compositions can comprise more than one herbicidal anion (e.g., 2, 3, 4, 5, 6, 7, 8, 9, 10, or more different herbicidal anions) with more than one kind of cation (e.g., 2, 3, 4, 5, 6, 7, 8, 9, 10 or more different kinds of cations). Specific examples include, but are not limited to, one kind of cation with 1, 2, 3, 4, 5, 6, 7, 8, 9, 10, or more herbicidal anions, 2 kinds of cations with 1, 2, 3, 4, 5, 6, 7, 8, 9, 10, or more herbicidal anions, 3 kinds of cations with 1, 2, 3, 4, 5, 6, 7, 8, 9, 10, or more herbicidal anions, 4 kinds of cations with 1, 2, 3, 4, 5, 6, 7, 8, 9, 10, or more herbicidal anions, 5 kinds of cations with 1, 2, 3, 4, 5, 6, 7, 8, 9, 10, or more herbicidal anions, 6 kinds of cations with 1, 2, 3, 4, 5, 6, 7, 8, 9, 10, or more herbicidal anions, 7 kinds of cations with 1, 2, 3, 4, 5, 6, 7, 8, 9, 10, or more herbicidal anions, 8 kinds of cations with 1, 2, 3, 4, 5, 6, 7, 8, 9, 10, or more herbicidal anions, 9 kinds of cations with 1, 2, 3, 4, 5, 6, 7, 8, 9, 10, or more herbicidal anions, 10 kinds of cations with 1, 2, 3, 4, 5, 6, 7, 8, 9, 10, or more herbicidal anions, or more than 10 kinds of cations with 1, 2, 3, 4, 5, 6, 7, 8, 9, 10, or more herbicidal anions.

Other specific examples include, but are not limited to, one kind of anion with 1, 2, 3, 4, 5, 6, 7, 8, 9, 10, or more kinds of cations, 2 herbicidal anions with 1, 2, 3, 4, 5, 6, 7, 8, 9, 10, or more kinds of cations, 3 herbicidal anions with 1, 2, 3, 4, 5, 6, 7, 8, 9, 10, or more kinds of cations, 4 herbicidal anions with 1, 2, 3, 4, 5, 6, 7, 8, 9, 10, or more kinds of cations, 5 herbicidal anions with 1, 2, 3, 4, 5, 6, 7, 8, 9, 10, or more kinds of cations, 6 herbicidal anions with 1, 2, 3, 4, 5, 6, 7, 8, 9, 10, or more kinds of cations, 7 herbicidal anions with 1, 2, 3, 4, 5, 6, 7, 8, 9, 10, or more kinds of cations, 8 herbicidal anions with 1, 2, 3, 4, 5, 6, 7, 8, 9, 10, or more kinds of cations, 9 herbicidal anions with 1, 2, 3, 4, 5, 6, 7, 8, 9, 10, or more kinds of cations, 10 herbicidal anions with 1, 2, 3, 4, 5, 6, 7, 8, 9, 10, or more kinds of cations, or more than 10 herbicidal anions with 1, 2, 3, 4, 5, 6, 7, 8, 9, 10, or more kinds of cations.

In addition to the cations and anions, the compositions disclosed herein can also contain nonionic species, such as solvents, preservatives, dyes, colorants, thickeners, surfactants, viscosity modifiers, mixtures and combinations thereof and the like. The amount of such nonionic species can range from less than about 99, 90, 80, 70, 60, 50, 40, 30, 20, or 10 wt. %

based on the total weight of the composition. In some examples described herein, the amount of such nonionic species is low (e.g., less than about 10, 9, 8, 7, 6, 5, 4, 3, 2, or 1 wt. % based on the total weight of the composition). In some examples described herein, the disclosed compositions are neat; that is, the only materials present in the disclosed compositions are the cations and anions that make up the composition. It is understood, however, that with neat compositions, some additional materials or impurities can sometimes be present, albeit at low to trace amounts (e.g., less than about 10, 9, 8, 7, 6, 5, 4, 3, 2, or 1 wt. % based on the total weight of the composition).

The disclosed compositions are liquid at some temperature range or point at or below about 150° C. For example, the disclosed compositions can be a liquid at or below about 150, 149, 148, 147, 146, 145, 144, 143, 142, 141, 140, 139, 138, 137, 136, 135, 134, 133, 132, 131, 130, 129, 128, 127, 126, 125, 124, 123, 122, 121, 120, 119, 118, 117, 116, 115, 114, 113, 112, 111, 110, 109, 108, 107, 106, 105, 104, 103, 102, 101, 100, 99, 98, 97, 96, 95, 94, 93, 92, 91, 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, 1, 0, −1, −2, −3, −4, −5, −6, −7, −8, −9,-10,-11,-12,-13,-14,-15,-16,-17, −18, −19, −20, −21, −22, −23, −24, −25, −26, −27, −28, −29, −30, −31, −32, −33, −34, −35, −36, −37, −38, −39, −40, −41, −42, −43, −44, −45, −46, −47, −48, −49, −50, −51, −52, −53, −54, −55, −56, −57, −58, −59, −60, −61, −62, −63, −64, −65, −66, −67, −68, −69, −70, −71, −72, −73, −74, −75, −76, −77, −78, −79, −80, −81, −82, −83, −84, −85, −86, −87, −88, −89, −90, −91, −92, −93, −94, −95, −96, −97, −98, −99, or −100° C., where any of the stated values can form an upper or lower endpoint when appropriate. In further examples, the disclosed compositions can be liquid at any point from about −30° C. to about 150° C., from about −20° C. to about 140° C., −10° C. to about 130° C., from about 0° C. to about 120° C., from about 10° C. to about 110° C., from about 20° C. to about 100° C., from about 30° C. to about 90° C., from about 40° C. to about 80° C., from about 50° C. to about 70° C., from about −30° C. to about 50° C., from about −30° C. to about 90° C., from about −30° C. to about 110° C., from about −30° C. to about 130° C., from about −30° C. to about 150° C., from about 30° C. to about 90° C., from about 30° C. to about 110° C., from about 30° C. to about 130° C., from about 30° C. to about 150° C., from about 0° C. to about 100° C., from about 0° C. to about 70° C., from about 0° to about 50° C., and the like.

Further, in some examples the disclosed compositions can be liquid over a wide range of temperatures, not just a narrow range of, for example, 1-2 degrees. For example, the disclosed compositions can be liquids over a range of at least about 4, 5, 6, 7, 8, 9, 10, or more degrees. In other examples, the disclosed compositions can be liquid over at least about an 11, 12, 13, 14, 15, 16, 17, 18, 19, 20, or more degree temperature range. Such temperature ranges can begin and/or end at any of the temperature points disclosed in the preceding paragraph.

In many examples disclosed herein, the disclosed compositions are liquid at the temperature at which they will be used or processed. For example, many of the disclosed compositions can be used as herbicides, which are liquid at the temperature of their use (e.g., ambient temperature). In other examples, the disclosed compositions can be liquid at the temperature at which they are formulated or processed.

As described above, it is understood that the disclosed compositions can be solubilized and solutions of the cations and anions are contemplated herein. Further, the disclosed compositions can be formulated in an extended or controlled release vehicle, for example, by encapsulating the compositions in microspheres or microcapsules using methods known in the art. Still further, the disclosed compositions can themselves be solvents for other solutes. For example, the disclosed compositions can be used to dissolve a particular nonionic or ionic herbicidal active. These and other formulations of the disclosed compositions are disclosed elsewhere herein.

The disclosed compositions can be substantially free of water in some examples (e.g., immediately after preparation of the compositions and before any further application of the compositions). By substantially free is meant that water is present at less than about 10, 9, 8, 7, 6, 5, 4, 3, 2, 1, 0.5, 0.25, or 0.1 wt. %, based on the total weight of the composition.

The disclosed compositions can be prepared by methods described herein. Generally, the particular cation(s) and anion(s) used to prepare an ionic liquid are selected as described herein. Then, with the particular cation(s) and anion(s) in hand, they can be combined, resulting in ionic liquid compositions as disclosed herein. The resulting ionic liquid can be then used in the ionic liquid form or diluted in a suitable solvent as described herein. Additionally, the method for the preparation of the disclosed compositions can include the reaction in which two neutral species: an anion precursor (e.g., in the form of an inorganic acid, carboxylic organic acid, non-carboxylic acid, or Zwitterion species) and a cation precursor (e.g., inorganic base, organic base, Zwitterion species) are combined resulting in ionic liquid compositions as disclosed herein. Again, such an ionic liquid can be used as is or diluted in an appropriate solvent. Still further, the disclosed compositions can be prepared by mixing in solution cations and anions, wherein the cations and anions are capable of forming an ionic liquid, an ion pair, a hydrogen bonded species, a complex, eutectic mixture, or a cocrystal, albeit under different nonsolvating conditions.

Providing ions used to prepare the disclosed compositions depends, in one aspect, on the desired properties of the resulting composition. As described herein, the disclosed compositions can have multiple desired properties, which, at least in part, come from the properties of the cation(s) and anion(s) used to prepare the compositions. Thus, to prepare the disclosed compositions, one or more kinds of cations with a desired property(ies) are provided. One or more herbicidal anions with a desired property(ies) that is similar or different to that of the cation(s) can likewise be provided. Of course, providing a desired herbicidal anion(s) and a cation(s) can be done in any order, depending on the preference and aims of the practitioner. For example, a particular cation(s) can be provided and then a particular herbicidal anion(s) can be provided. Alternatively, a particular herbicidal anion(s) can be provided and then a particular cation(s) can be provided. Further, the cation(s) and herbicidal anion(s) can be provided simultaneously.

As noted, providing a suitable ion can be based on selecting an ion that possesses a property that is desired (e.g., the ion has a property that is desired to be possessed by the resulting compositions). Most preferably, the particular cations and anions are chosen such that they have the ability to form an ionic liquid, though they need not be actually used in that particular form. Moreover, each ion in the compositions contributes to distinctive physical, chemical, and biological properties of the resulting salt, and thus, ionic liquid herbicides can be fine tuned to overcome unfortunate problems in use while maintaining the biological efficacy of the active ingredient. Examples of other properties that could be desired in a suitable cation and/or anion (and thus the compositions made therefrom) include, but are not limited to, herbicidal, and pesticidal (e.g., antimicrobial, fungicidal, algaecidal, insecticidal, miticidal, molluscicidal, nematicidal, rodenticidal, and virucidal) activity. Viscosity modulation, solubility modulation, stability, and toxicity are other properties of a given ion that could be desired and considered. While more specific properties are disclosed elsewhere herein, the disclosed methods and compositions are not limited to any particular combination of properties, as such will depend on the preferences and goals of the practitioner.

Typically, the desired properties of the cation(s) and herbicidal anion(s) will be different or complimentary to one another. In this way, the resulting compositions can possess multiple desired properties: those properties imparted by the cation(s) and those imparted by the herbicidal anion(s). In other words, some or all of the ions present in the disclosed compositions can independently and simultaneously introduce a specific functionality or property to the disclosed compositions. It is this multiple functionality characteristic that can allow one to fine-tune or design very specific physical, chemical, and bioactive properties in the disclosed herbicidal compositions. Additional functionality can be obtained by using the disclosed herbicidal compositions as solvents to dissolve a solute(s) with another desired property, thus resulting in a solution where the ions of the compositions as well as the solute contribute desired properties to the composition. General and specific examples of various combinations of ions and their associated properties are disclosed herein.

In some particular examples, one or more ions in the disclosed compositions (e.g., the anions, cations, or both) can be an herbicidal active, e.g., an existing herbicide that is ionic or that can be made ionic. Many herbicides exist naturally or at physiological conditions as an ion, or they can be converted to ions via simple chemical transformations (e.g., alkylation, protonation, deprotonation, etc.). As such, these herbicides can be used to prepare a composition as disclosed herein. Such herbicides can further possess additional pesticidal activity, many of which are described herein. Combining such herbicides with other ions to prepare an ionic liquid, as is disclosed herein, can result in the modification and/or enhancement of the herbicides' properties. Similarly, combining in solution these particular combinations of ions can also result in modification and/or enhancement of the herbicides' properties. For example, a first herbicide ion with a given property can be combined with an oppositely charged second ion with another property to effect the slow or controlled release, slow or controlled delivery, or desired physical properties (stability, solubility, toxicity, melting point, etc.), in the herbicidal formulation . In this way, new herbicide compositions can be created by forming ionic liquids or solutions with functionality crafted into the combination of the ions, as disclosed herein.

As another example, the first herbicidal anion can be combined with a second ion (e.g., a cation) that has properties complimentary to the first. Examples of this can include, but are not limited to, an ion having herbicidal properties being combined with an ion having antimicrobial properties, an ion having herbicidal properties being combined with an ion having fungicidal properties, or an ion having herbicidal properties being combined with an ion having other pesticidal properties. Ionic liquids or solutions resulting from such combinations could find uses as multi-purposed crop protection agents, for example. Further examples can include two differently charged ions each with similar uses but with different mechanisms of action. Specific examples of such combinations can include, but are not limited to, combinations of ions with selective herbicidal properties or non-selective herbicidal properties.

According to the methods and compositions disclosed herein, ion identification and combination, as disclosed herein, can involve any ion as long as the combination would result in an ionic liquid. As should be appreciated, the various combinations of ions according to the disclosed methods are numerous, and depend only on the desired combination of properties and whether the resulting ion combination is an ionic liquid as defined herein.

### Ions

The disclosed compositions contain at least one herbicidal anion and at least one kind of cation. In some examples, the compositions can contain at least one herbicidal cation. Examples of suitable anions and cations are disclosed herein. It should be understood that when a particular compound is disclosed as being a cation, for example, it can also, in other circumstances, be an anion and vice versa. Many compounds are known to exist as cations in some environments and anions in other environments. Further, many compounds are known to be convertible to cations and anions through various chemical transformations. Examples of such compounds are disclosed herein.

The materials, compounds, compositions, and components that can be used for, can be used in conjunction with, can be used in preparation for, or are products of the disclosed methods and compositions are disclosed herein. It is understood that when combinations, subsets, interactions, groups, etc. of these materials are disclosed that while specific reference of each various individual and collective combinations and permutation of these compounds may not be explicitly disclosed, each is specifically contemplated and described herein. For example, if a composition is disclosed and a number of modifications that can be made to a number of components of the compositions are discussed, each and every combination and permutation that are possible are specifically contemplated unless specifically indicated to the contrary. Thus, if a class of cations A, B, and C are disclosed as well as a class of anions D, E, and F and an example of a ionic liquid A-D is disclosed, then even if each is not individually recited, each is individually and collectively contemplated. Thus, in this example, each of the ionic liquids A-E, A-F, B-D, B-E, B-F, C-D, C-E, and C-F are specifically contemplated and should be considered disclosed from disclosure of A, B, and C; D, E, and F; and the example ionic liquid A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific aspect or combination of aspects of the disclosed methods, and that each such combination is specifically contemplated and should be considered disclosed.

### Anions

### Herbicidal Anions

As described above, the at least one herbicidal anion can include anions of Dicamba (i.e., 3,6-dichloro-2-methoxybenzoic acid), Mecoprop (i.e., (±)-2-(4-chloro-2-methylphenoxy)propionic acid), Mecoprop-P (i.e., (+)-(R)-2-(4-chloro-2-methylphenoxy)propionic acid), or Glyphosate (i.e., N-(phosphonomethyl)glycine). The anions of these herbicides can be formed, for example, by deprotonation of one or more acidic protons of the molecules. Examples of protons that can be deprotonated to form the herbicidal anions include, but are not limited to, those indicated with an asterisk (*) in the structures shown below:

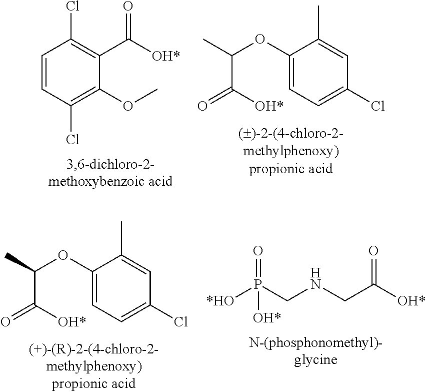

Further examples of suitable herbicides that can be included as a second anion or as a cation include, but are not limited to, carfentrazone, imazapyr, benefin, acifluorfen, and 2-[2-chloro-3-(2.2,2-trifluoroethoxymethyl)-4-methylsulfonylbenzoyl]cyclohexane-1. Other suitable herbicides include inhibitors of the biosynthesis of branched amino acids such as ethoxysulfuron, flumetsulam, halosulfuron, imazamox, imazapyr, imazaquin, imazethapyr, metosulam, nicosulfuron, primisulfuron, prosulfuron, rimsulfuron, thifensulfuron-methyl, triflusulfuron, N-[(4.6-dimethoxypyrimidin-2-yl)aminocarbonyl]-2-dimethylaminocarbonyl-5-formylaminobenzenesulfonamide (Foramsulfuron), and the like. Still further, suitable herbicides include inhibitors of the photosynthesis electron transport such as ametryne, atrazine, bromoxynil, cyanazine, diuron, hexazinone, metribuzin, pyridate, terbuthylazine, and the like. In yet further examples, suitable herbicides for the disclosed compositions include synthetic auxins such as copyralid, dicamba, diflufenzopyr, fluroxypyr, and the like. Inhibitors of fatty acid biosynthesis, such as butylate, EPTC, fenoxaprop-P-ethyl, and the like, can also be used in the disclosed ionic liquid compositions. In other examples, suitable herbicides can include inhibitors of cell division such as acetochlor, alachlor, dimethenamid, flufenacet, mefenacet, metolachlor, S-metolachlor, thenylchlor, and the like. In still other examples, the herbicide can be an inhibitor of protoporphyrinogen oxidase, such as fluthiacet-methyl, carfentrazone-ethyl, and the like. Inhibitors of hydroxyphenylpyruvate dioxygenase, such as isoxaflutole, mesotrione, sulcotrione, 4-(4-trifluoromethyl-2-methylsulfonylbenzoyl)-5-hydroxy-1-methyl-3-methylpyrazole, and the like, can also be used. Further examples of suitable herbicides include, but are not limited to, pendimethalin, trifluralin, asulam, triaziflam, diflufenican, glufosinate-ammonium, and the like. Clofencet, fluroxpyr, mesosulfuron, diflufenzopyr are further examples of suitable herbicides.

### Additional Anions

The at least one herbicidal anion can further include additional anionic compounds. Particular examples of anionic compounds that can be present in the disclosed compositions are compounds that contain oxygen atoms. Oxygen atom-containing groups can exist as neutral or can be converted to negatively charged, anionic species, for example, through deprotonation of alcohols or acids, through saponification of esters, or through alkylation of ketones. Likewise, compounds that contain sulfur atoms can also exist or be converted to anionic species through similar reactions. Still further, compounds that contain nitrogen atoms, especially nitrogen atoms adjacent to electron withdrawing groups or resonance stabilizing structures, can be converted to anions through deprotonation. According to the methods and compositions disclosed herein, any compound that contains an oxygen, sulfur, or nitrogen atom can be a suitable anion for the disclosed compositions.

### Cations

Particular examples of cationic compounds that can be present in the disclosed compositions are compounds that contain nitrogen or phosphorus atoms. Nitrogen atom-containing groups can exist as neutral or can be converted to positively-charged quaternary ammonium species, for example, through alkylation or protonation of the nitrogen atom. Thus, compounds that possess a quaternary nitrogen atom (known as quaternary ammonium compounds (QACs)) are typically cations. According to the methods and compositions disclosed herein, any compound that contains a quaternary nitrogen atom or a nitrogen atom that can be converted into a quaternary nitrogen atom can be a suitable cation for the disclosed compositions. In some examples, the cation is not a protonated tertiary amine, a protonated heteroarylamine, a protonated pyrrolidine, or a metal.

QACs can have numerous biological properties that one may desire to be present in the disclosed compositions. For example, many QACs are known to have antibacterial properties. The antibacterial properties of QACs were first observed toward the end of the 19^{th} century among the carbonium dyestuffs, such as auramin, methyl violet, and malachite green. These types of compounds are effective chiefly against the Gram-positive organisms. Jacobs and Heidelberger first discovered QACs antibacterial effect in 1915 studying the antibacterial activity of substituted hexamethylene-tetrammonium salts (Jacobs and Heidelberger, Proc Nat Acad Sci USA, 1915, 1:226; Jacobs and Heidelberger, J Biol Chem, 1915, 20:659; Jacobs and Heidelberger, J Exptl Med, 1916, 23:569).

Browning et al. found great and somewhat less selective bactericidal powers among quaternary derivatives of pyridine, quinoline, and phenazine (Browning et al., Proc Roy Soc London, 1922, 93B:329; Browning et al., Proc Roy Soc London, 1926, 100B:293). Hartman and Kagi observed antibacterial activity in QACs of acylated alkylene diamines (Hartman and Kagi, Z Angew Chem, 1928, 4:127).

In 1935, Domagk synthesized long-chain QACs, including benzalkonium chloride, and characterized their antibacterial activities (Domagk, Deut Med Wochenschr, 1935, 61:829). He showed that these salts are effective against a wide variety of bacterial strains. This study of the use of QACs as germicides was greatly stimulated.

Many scientists have focused their attention on water soluble QACs because they exhibit a range of properties: they are surfactants, they destroy bacteria and fungi, they serve as a catalyst in phase-transfer catalysis, and they show anti-electrostatic and anticorrosive properties. They exert antibacterial action against both Gram-positive and Gram-negative bacterial as well as against some pathogen species of fungi and protozoa. These multifunctional salts have also been used in wood preservation, their application promoted in the papers of Oertel and Butcher et al. (Oertel, Holztechnologie, 1965, 6:243; Butcher et al., For Prod J, 1977, 27:19; Butcher et al., J For Sci, 1978, 8:403). Many examples of compounds having nitrogen atoms, which exist as quaternary ammonium species or can be converted into quaternary ammonium species, are disclosed herein.

### Aliphatic Heteroaryls

Some specific QACs suitable for use herein are aliphatic heteroaryls. An aliphatic heteroaryl cation is a compound that comprises at least one aliphatic moiety bonded to a heteroaryl moiety. In the aliphatic heteroaryl cation, the aliphatic moiety can be any alkyl, alkenyl, alkynyl, heteroalkyl, heteroalkenyl, heteroalkynyl, cycloalkyl, cycloalkenyl, heterocycloalkyl, or heterocycloalkenyl group, as described herein. For example, the aliphatic moiety can include substituted or unsubstituted C₁₋₂₀ alkyl, substituted or unsubstituted C₂₋₂₀ alkenyl, substituted or unsubstituted C₂₋₂₀ alkynyl, substituted or unsubstituted C₁₋₂₀ heteroalkyl substituted or unsubstituted C₂₋₂₀ heteroalkenyl, or substituted or unsubstituted C₂₋₂₀ heteroalkynyl groups. Generally, the aliphatic moiety can comprise at least 10, at least 12, at least 14, at least 16, at least 18, or at least 20 carbon atoms. In other examples, the aliphatic moiety can comprise a mixture of aliphatic groups having a range of carbon atoms. For example, the aliphatic moiety can comprise from 10 to 40, from 12 to 38, from 14 to 36, from 16 to 34, from 18 to 32, from 14 to 18, or from 20 to 30 carbon atoms. In some specific examples, the aliphatic moiety can contain 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, or 45 carbon atoms, where any of the stated values can form an upper or lower endpoint when appropriate. Examples of specific aliphatic moieties that can be used include, but are not limited to, decyl, dodecyl (lauryl), tetradecyl (myristyl), hexadecyl (palmityl or cetyl), octadecyl (stearyl), eicosyl (arachidyl), and linolenyl groups, including branched derivatives thereof and any mixtures thereof. For example, the aliphatic moieties can include coco, tallow, hydrogenated tallow, oleyl, or soya groups. The aliphatic moieties can further include alkoxymethyl groups (e.g., containing from 2 to 19 carbon atoms) or cycloalkoxymethyl groups (e.g., containing from 5 to 13 carbon atoms). In the aliphatic heteroaryl cations, the aliphatic moiety is bonded to a heteroatom in the heteroaryl moiety.

In the aliphatic heteroaryl cation, the heteroaryl moiety can be any heteroaryl moiety as described herein. For example, the heteroaryl moiety can be an aryl group having one or more heteroatoms (e.g., nitrogen, oxygen, sulfur, phosphorous, or halonium). Examples of specific heteroaryl moieties that can be used in the aliphatic heteroaryl cations include, but are not limited to, substituted or unsubstituted pyrazoles, substituted or unsubstituted pyridines, substituted or unsubstituted pyrazines, substituted or unsubstituted pyrimidines, substituted or unsubstituted pryidazines, substituted or unsubstituted indolizines, substituted or unsubstituted isoindoles, substituted or unsubstituted indoles, substituted or unsubstituted indazoles, substituted or unsubstituted imidazoles, substituted or unsubstituted oxazoles, substituted or unsubstituted triazoles, substituted or unsubstituted thiazoles, substituted or unsubstituted purines, substituted or unsubstituted isoquinolines, substituted or unsubstituted quinolines, substituted or unsubstituted phthalazines, substituted or unsubstituted quinooxalines, substituted or unsubstituted phenazine, and the like, including derivatives and mixtures thereof. In the aliphatic heteroaryl cations, a heteroatom in the heteroaryl moiety is bonded to the aliphatic moiety. When the heteroatom of the heteroaryl is nitrogen, this forms a quaternary ammonium cation, as described herein.

Further examples of aliphatic heteroaryl cations include substituted or unsubstituted benztriazoliums, substituted or unsubstituted benzimidazoliums, substituted or unsubstituted benzothiazoliums, substituted or unsubstituted pyridiniums, substituted or unsubstituted pyridaziniums, substituted or unsubstituted pyrimidiniums, substituted or unsubstituted pyraziniums, substituted or unsubstituted imidazoliums, substituted or unsubstituted pyrazoliums, substituted or unsubstituted oxazoliums, substituted or unsubstituted 1,2,3-triazoliums, substituted or unsubstituted 1,2,4-triazoliums, substituted or unsubstituted thiazoliums, substituted or unsubstituted piperidiniums, substituted or unsubstituted pyrrolidiniums, substituted or unsubstituted quinoliums, and substituted or unsubstituted isoquinoliums.

### Aliphatic Benzylalkyl Ammonium

The disclosed compositions can also comprise an aliphatic benzylalkyl ammonium cation. An aliphatic benzylalkyl ammonium cation is a cation that comprises an aliphatic moiety bonded to the nitrogen atom of a benzylalkyl amine moiety. The aliphatic moiety can be as described herein. The benzylalkyl amine moiety can be a benzyl amine where the amine is bonded to an alkyl or cyclic alkyl group, as described herein. One or more types of aliphatic benzylalkyl ammonium cation can be used in the compositions disclosed herein. The aliphatic benzylalkyl ammonium cation suitable for use herein can be prepared by methods known in the art or can be obtained from commercial sources.

In one aspect, the aliphatic benzylalkyl ammonium cation can be represented by the following formula:

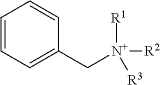

wherein R¹ is an aliphatic group as described above and R² and R³ are, independent of one another, alkyl groups or cyclic alkyl groups as described herein. In some examples, one or more of the “R” substituents can be a long chain alkyl group (e.g., the number of carbon atoms is 10 or greater). In other examples, one or more of the “R” substituents can be a short chain alkyl group (e.g., the number of carbon atoms is less than 10). In still other examples, one of the “R” substituents is a long chain alkyl group and the other two “R” substituents are short chain alkyl groups.

In one aspect, the aliphatic benzylalkyl ammonium cation can have any of the aliphatic moieties disclosed herein bonded to any benzylalkyl amine moieties disclosed herein. In some specific examples, R¹ in the formula of aliphatic benzylalkyl ammonium cation can be an aliphatic group of from 10 to 40 carbon atoms, e.g., a decyl, dodecyl (lauryl), tetradecyl (myristyl), hexadecyl (palmityl or cetyl), octadecyl (stearyl), or eicosyl (arachidyl) group, and R² and R³ can each be, independent of one another, a methyl, ethyl, propyl, butyl, pentyl, or hexyl group.

In another aspect, the aliphatic benzylalkyl ammonium cation can include, but are not limited to, alkyl dimethyl benzyl ammonium cations. Specific examples of alkyl dimethyl benzyl ammonium cations include, but are not limited to, cetyl dimethyl benzyl ammonium, lauryl dimethyl benzyl ammonium, myristyl dimethyl benzyl ammonium, stearyl dimethyl benzyl ammonium, and arachidyl dimethyl benzyl ammonium.

In yet another aspect, the aliphatic benzylalkyl ammonium cation can include, but are not limited to, alkyl methylethyl benzyl ammonium cations. Specific examples of alkyl methylethyl benzyl ammonium cations include, but are not limited to, cetyl methylethyl benzyl ammonium, lauryl methylethyl benzyl ammonium, myristyl methylethyl benzyl ammonium, stearyl methylethyl benzyl ammonium, and arachidyl methylethyl benzyl ammonium.

### Dialiphatic Dialkyl Ammonium

Still further examples of QACs that can be used in the disclosed compositions are dialiphatic dialkyl ammonium cations. A dialiphatic dialkyl ammonium cation is a compound that comprises two aliphatic moieties and two alkyl moieties bonded to a nitrogen atom. The aliphatic moieties can be the same or different and can be any aliphatic group as described above. The alkyl moieties can be the same or different can be any alkyl group as described above. In the disclosed dialiphatic dialkyl ammoniums cations, the two aliphatic moieties can have 10 or more carbon atoms and the two alkyl moieties can have less than 10 carbon atoms. In another alternative, the two aliphatic moieties can have less than 10 carbon atoms and the two alkyl moieties can have 10 or more carbon atoms. One or more types of dialiphatic dialkyl ammonium cations can be used in the compositions disclosed herein.

In some particular examples, the dialiphatic dialkyl ammonium cation can be di-dodecyl dimethyl ammonium, di-tetradecyl dimethyl ammonium, dihexadecyl dimethyl ammonium, and the like, including combinations thereof

### Tetraalkyl Ammonium

The disclosed compositions can also comprise a tetraalkyl ammonium cation. Suitable tetraalkyl ammonium cations comprise four alkyl moieties, as disclosed herein. In one example, a tetraalkyl ammonium cation can comprise one long chain alkyl moiety (e.g., 10 or more carbon atoms in length) and three short chain alkyl moieties (e.g., less than 10 carbon atoms in length).

Some specific examples of tetraalkyl ammonium cations that can be included in the disclosed compositions include, but are not limited to, cetyl trimethyl ammonium, lauryl trimethyl ammonium, myristyl trimethyl ammonium, stearyl trimethyl ammonium, arachidyl trimethyl ammonium, or mixtures thereof. Other examples include, but are not limited to, cetyl dimethylethyl ammonium, lauryl dimethylethyl ammonium, myristyl dimethylethyl ammonium, stearyl dimethylethyl ammonium, arachidyl dimethylethyl ammonium, or mixtures thereof

### Other Cations

Another suitable group of quaternary ammonium cations are those that have been prepared by esterifying a compound containing a carboxylic acid moiety or transesterifying a compound with an ester moiety with a choline moiety. Such choline esters can be biofriendly, permanent ions that are amenable to being added to various compounds while still being easily cleavable under physiological conditions. The choline esters can be used to increase the solubility and bioavailability of many neutral compounds.

Further examples of cations include (2-hydroxyethyl)-dimethylundecyloxymethylammonium, (2-acetoxyethyl)-heptyloxymethyldimethylammonium, and (2-acetoxyethyl)-dodecyloxymethyldimethylammonium, mepenzolate, sulfathiazole, thimerosal, and valproic acid.

### Specific Compositions

Because the disclosed compositions can have multiple functionalities or properties, each arising from the various ions that make up the compositions, the disclosed compositions can be custom designed for numerous uses. As disclosed herein, any combination of cations and anions, as disclosed herein, can be made as long as the combination would result in an ionic liquid as described herein. That is, any compound or active disclosed herein that has a given charge or can be made to have a given charge (the “first ion(s)”) and can be combined with any other compound or active disclosed herein having a charge opposite to that of the first ion(s) or any compound that can be made to have a charge opposite to that of the first ion(s) to form an ionic liquid is suitable. Thus, in many examples, the compositions can have one type of cation and one type of anion, in a 1:1 relationship, so that the net charge of the ionic liquid is zero.

Furthermore, many of the ions disclosed herein can have multiple charges. Thus, when one ion having a multiple charge is used, more counterion(s) is needed, which will affect the ratio of the two ions. For example, if a cation having a plus 2 charge is used, then twice as much anion having a minus 1 charge is needed. If a cation having a plus 3 charge is used, then three times as much anion having a minus 1 charge is needed, and so on. While the particular ratio of ions will depend on the type of ion and their respective charges, the disclosed compositions can have a cation to anion ratio of 1:1:, 2:1, 3:1, 4:1, 1:3, 2:1, 3:2, 2:3, and the like.

Many of the compositions disclosed herein can also have more than one different kind of cation and/or more than one different kind of anion. The use of more than one kind of cation and/or anion can be particularly beneficial when one prepares a composition comprising two or more bioactive ions that are not desired to be in a 1:1 relationship. In other words, according to the disclosed methods, the disclosed compositions that contain varying effective amounts of active substances can be prepared by varying the ratios of ions in the composition, as long as the total amount of cations is balanced by the total amount of anions. For example, a composition as disclosed herein can contain one type of cation with a given property and two different anions (e.g., a first and second anion), each with another different property. The resulting ionic liquid in this example will be 1 part cation, 0.5 part first anion, and 0.5 part second anion. Another example of this adjustment in ion amounts can arise when one ion is particularly potent and thus dilution is desired. For example, a first cation that is particularly potent can be combined with a second (or third, forth, etc.) cation that is inert or has so other property that is desired. When these cations are combined with one or more herbicidal anions to form an ionic liquid, the amount of the first cation is diluted by the other the cation(s). As will be appreciated, many other such variations in the amount of cations and anions can be present in the disclosed methods and compositions. Thus, while specific ionic liquid compositions having particular combinations of cations and anions are disclosed herein, it is understood that the ratio of the particular ions can be varied or adjusted by adding other ions, so long as there is a balance of charge and the final composition is an ionic liquid. Moreover, solutions of these combination of ions are also contemplated herein, whether prepared by diluting an ionic liquid that was prepared beforehand or by mixing the ions directly into solution.

When the disclosed compositions have two or more ions with a bioactive property (e.g., herbicidal actives, fungicidal actives, antimicrobials, and the like), these compositions can be particularly desired because each of the active ingredients in the composition would dissolve together when formulated or administered. This can be particularly useful when overcoming formulation, solubility, mobility, and size issues. Further, when exact dosages of an active ingredient are needed, the active ingredient as an ion can be combined with a counterion that is innocuous or GRAS (generally recognized as safe). As noted above, for example, if one active ingredient (cation) is needed at half the dosage of another active ingredient (anion), then an innocuous cation could be used as filler to balance the charges. This same concept applies if more cation is needed than anion.

As described above, the herbicidal compositions can be prepared from one or more of the anions of Mecoprop-P or Mecoprop (Mecoprop-P shown), Dicamba, or Glyphosate, as shown below.

### Anions

| Identification | Structure | Anion Name |
|---|---|---|
| MCPP | 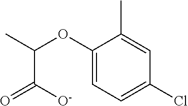 | Mecoprop or (±)-2-(4-chloro-2- methylphenoxy)propionic acid |
| MCPP-P | 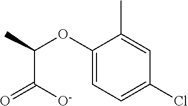 | Mecoprop-P or (+)-R-2-(4-chloro-2- methylphenoxy)propionic acid |
| Dicamba | 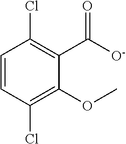 | 3,6-Dichloro-2-methoxybenzoic acid |
| Glyphosate | 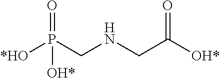 | Glyphosate or N-(phosphonomethyl) glycine |

Each of the four anions shown above can be combined with any of the cations as described herein. For example, each of the four anions can individually be combined with an ammonium cation of the following formulas. In each of the cations, R¹, R², R³, and R⁴ can each independently be, for example, a straight alkyl chain containing from 1 to 18 carbon atoms or a mixture of alkyl chains of 1 to 20 carbon atoms including common names coco or tallow or hydrogenated tallow or oleyl or soya, or straight-alkoxymethyl group containing from 2 to 19 carbon atoms or the cycloalkoxymethyl group with 5 to 13 carbon atoms.

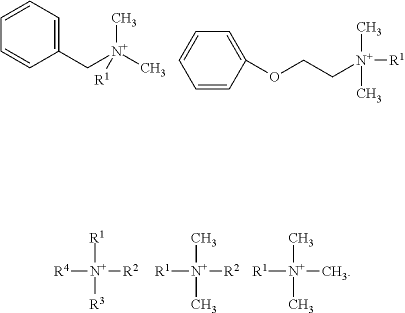

Further, the three anions can be combined with a pyridinium cation, an imidazolium cation, a morpholinium cation, a pyrrolidinium cation, or a piperidinium cation as shown below.

In each of the cations, R¹ and R² can each independently be, for example, a straight alkyl chain containing from 1 to 18 carbon atoms or a mixture of alkyl chains of 1 to 20 carbon atoms including common names coco or tallow or hydrogenated tallow or oleyl or soya, or straight-alkoxymethyl group containing from 2 to 19 carbon atoms or the cycloalkoxymethyl group with 5 to 13 carbon atoms.

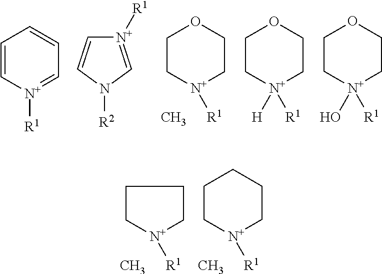

In some examples, one of the three anions listed above can be combined with an ammonium cation as shown below.

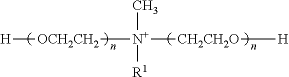

In these examples, R¹ is a straight-alkyl group containing from 1 to 18 carbon atoms or a mixture of alkyl chain of 1 to 20 carbon atoms including common names coco or tallow or hydrogenated soya, or tallow, or oleyl where n is equal to 1 to 12.

One of the three anions listed above can also be combined with a quinolinium or isoquinolinium cation as shown below.

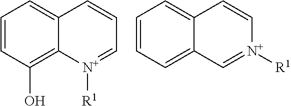

In these examples, R¹ represents a proton or a straight-alkyl group containing from 1 to 18 carbon atoms, a straight-alkoxymethyl group containing from 2 to 19 carbon atoms, a cycloalkoxymethyl, or a group containing from 5 to 13 carbon atoms.

The anions can also be combined with a phosphonium cation of the structure ⁺PR¹R²R³R⁴, where R is an alkyl group containing from 1 to 12 carbon atoms.

One of the three anions listed above can be combined with an ammonium cation as shown below. In these structures, R¹, R², and R³ can each independently be can be a straight-alkyl group containing from 1 to 18 carbon atoms or a mixture of alkyl chain of 1 to 20 carbon atoms (common names coco or tallow or hydrogenated soya, or tallow, or oleyl) and n is equal to from 1 to 12.

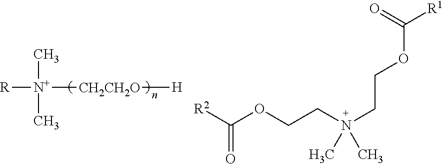

In some examples, one of the anions is paired with an ammonium cation of the following structure:

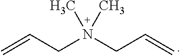

In some examples, the anions shown above can be paired with an N-substituted nicotinamide cation as shown in the following formula:

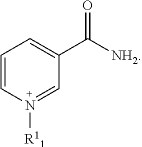

In this formula, R¹ can be a straight-alkyl group containing from 1 to 18 carbon atoms or straight-alkoxymethyl group containing from 2 to 19 carbon atoms or cycloalkoxymethyl or a group containing from 5 to 13 carbon atoms.

In some examples, the anions shown above can be paired with a polyetherammonium cation. For example, the anions shown above can be paired with a polyether-monoammonium cation or a polyether-diammonium cation as shown below:

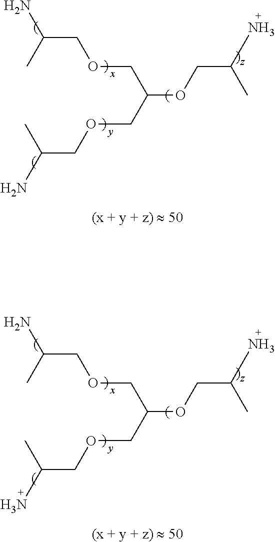 [SMILES: CC(N)COCC(COCC(C)N)OCC(C)N ; CC(N)COCC(COCC(C)N)OCC(C)N]

The polyetherammonium cations can be prepared from commercially available polyetheramines. Examples of suitable polyetheramines for use as polyetherammonium precursors include the

JEFFAMINE series (e.g., JEFFAMINE 3000) commercially available from Huntsman Corp. (The Woodlands, TX).

Further, the anions described herein can be paired with a cation of the following formula:

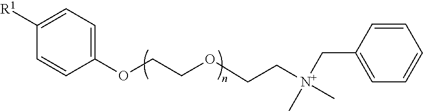

wherein R¹ is a straight- or branched (including benzethonium) alkyl group containing from 1 to 18 carbon atoms and n- is equal to from 0 to 12.

In some examples, the Mecoprop-P anion can be combined with one of several cations as shown below.

### Cations

| Structure | Cation Name |
|---|---|
| 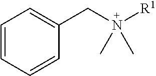 | Benzalkonium [BA] R = C₁₂H₂₅ or C₁₄H₂₉ |
| 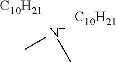 | Didecyldimethylammonium [DDA] |
| 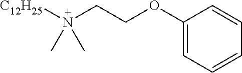 | Domiphen [DOM] |
| 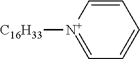 | 1-Hexadecylpyridinium [C16PIR] |
| 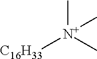 | Hexadecyltrimethylammonium [CTA] |
| 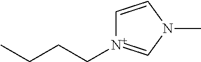 | 3-Buty1-1-methylimidazolium [C4IM] |
| 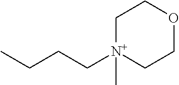 | 4-Butyl-4-methylmorpholinium [C4MOR] |
| 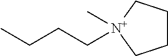 | 1-Butyl-1-methylpyrrolidinium [C4PIROL] |
| 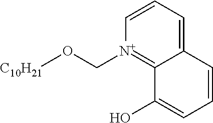 | 1-Decyloxymethy1-8-hydroxquinolinium [OC10CHIN] |
| 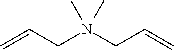 | Diallyldimethylammonium |
| 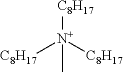 | Trioctylmethylammonium |
| 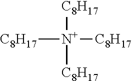 | Tetraoctylphosphonium |
| 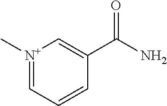 | 3-Carbamoyl-1-methylpyridinium |
| 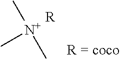 | Alkyltrimethylammonium (e.g., alkyl as coco) |
| 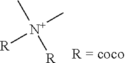 | Dialkyldimethylammonium (e.g., alkyl as coco) |
| 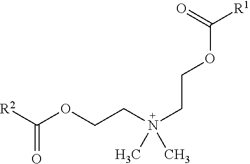 | Esterquatu |
| 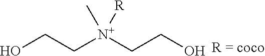 | Alkyldi(2-hydroxyethyl)methylammonium (e.g., alkyl as coco) |
| 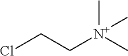 | 2-Chloroethyltrimethylammonium |
| 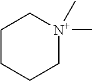 | 1,1-Dimethylpiperidinium |

In some examples, the Dicamba anion can be combined with one of several cations as shown below.

### Cations

| Structure | Cation Name |
|---|---|
| 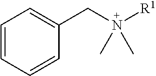 | Benzalkonium [BA] R = C₁₂H₂₅ or C₁₄H₂₉ |
| 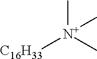 | Didecyldimethylammonium [DDA] |
| 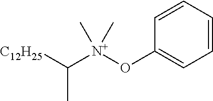 | Dodecyldimethylphenoxyethylammonium |
| 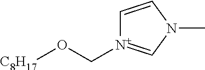 | 1-Methyl-3-octyloxymethylimidazolium |
| 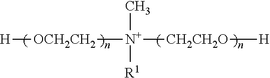 | Alkyldipolyoxyethylene (15)-methylammonium (e.g., alkyl as hydrogenated tallow) |
| 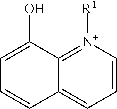 | 1-Alkyl-8-hydroxyquinolinium- (e.g., alkyl as coco) |
| 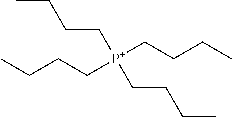 [SMILES: CCCC[P+](CCCC)(CCCC)CCCC] | Tetrabutylphosphonium |
| 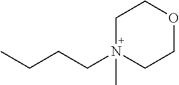 | 1-Butyl-1-methylmorpholinium |
| 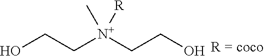 | Alkyldi(2-hydroxyethyl)methylammonium (e.g., alkyl as coco) |
| 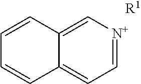 | 1-Alkylisoquinolinium (e.g., alkyl as coco) |
| 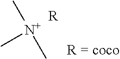 | Alkyltrimethylammonium [ATMA] (e.g., alkyl as coco) |
| 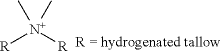 | Di(hydrogenated tallow)dimethylammonium |
| 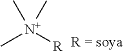 | Soyatrimethylammonium |
| 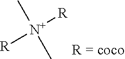 | Dialkyldimethylammonium (e.g., alkyl as coco) |
| 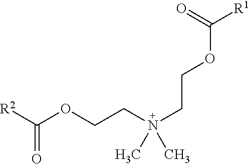 | Dialkyl dimethyl ester quaternary ammonium (e.g., alkyl as coco) |
| 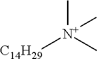 | Myristyltrimethylammonium |
| 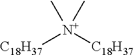 | Dioctadecyldimethylammonium |
| 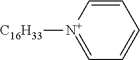 | 1-Hexadecylpyridinium [C16PIR] |
| 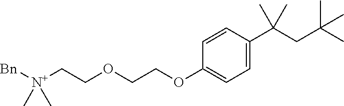 [SMILES: CC(C)(C)CC(C)(C)c1ccc(OCCOCC[N+](C)(C)Cc2ccccc2)cc1] | Benzethonium |
| 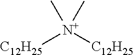 | Didodecyldimethylammonium |
| 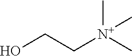 | 2-Hydroxyethyltrimethylammonium |
| 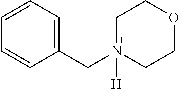 | 4-Benzylmorpholinium |
| 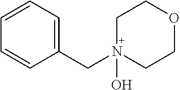 | 4-Benzyl-4-Hydroxymorpholinium |
| 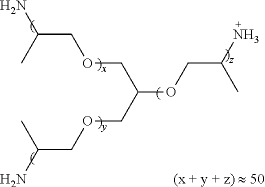 | Polyether-monoammonium |
| 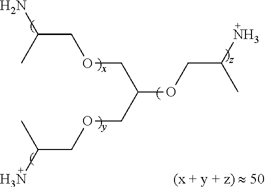 | Polyether-diammonium |

In some examples, the composition is not didecyldimethylammonium 3,6-dichloro-2-methoxybenzoate [DDA][Dicamba]; benzalkonium 3,6-dichloro-2-methoxybenzoate; dodecyldimethylphenoxyethylammonium 3,6-dichloro-2-methoxybenzoate; 1-dodecylopyridinium 3,6-dichloro-2-methoxybenzoate; 1-methyl-3-octyloxymethylimidazolium 3,6-dichloro-2-methoxybenzoate; alkyldipolyoxyethylene (15)methylammonium 3,6-dichloro-2-methoxybenzoate; 1-alkyl-8-hydroxyquinolinium 3,6-dichloro-2-methoxybenzoate; tetrabutylphosphonium 3,6-dichloro-2-methoxybenzoate; 1-butyl-1-methylmorpholinium 3,6-dichloro-2-methoxybenzoate; alkyldi(2-hydroxyethyl)methylammonium 3,6-dichloro-2-methoxybenzoate; 1-alkylisoquinolinium 3,6-dichloro-2-methoxybenzoate; or alkyltrimethylammonium 3,6-dichloro-2-methoxybenzoate [ATMA] [Dicamba].

In some examples, the Glyphosate anion can be combined with one or more of several cations as shown below.

### Cations

| Structure | Cation Name |
|---|---|
| 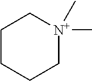 | 1,1-Dimethylpiperidinium |
| 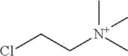 | 2-Chloroethyltrimethylammonium |
| 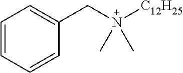 | Benzalkonium [BA] |
| 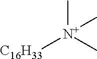 | Didecyldimethylammonium [DDA] |
| 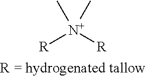 | Di(hydrogenated tallow)dimethylammo- nium |
| 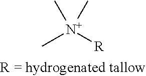 | (Hydrogenated tallow)trimethylammo- nium |
| 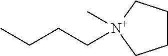 | 1-Butyl-1-methylpyrrolidinium [C4PIROL] |
| 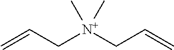 | Diallyldimethylammonium |
| 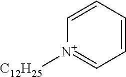 | 1-Dodecylpyridinium |
| 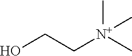 | Choline |
| 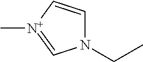 | 1-Ethy1-3-methylimidazolium |
| 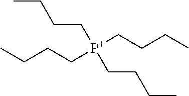 [SMILES: CCCC[P+](CCCC)(CCCC)CCCC] | Tetrabutylphosphonium |
| 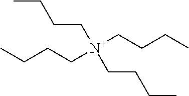 [SMILES: CCCC[N+](CCCC)(CCCC)CCCC] | Tetrabutylammonium |
| 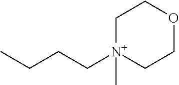 | 4-Butyl-4-methylmorpholinium [C4MOR] |
| 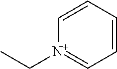 | 1-Ethylpyridinium |

### D. Preparation of the Compositions

The disclosed compositions can be prepared by combining one or more kinds of cations or cation precursors with one or more herbicidal anions or herbicidal anion precursors. This can be done to form an ionic liquid, which can be used as it is or diluted by a solvent, or the ions or ion precursors can be mixed directly in a solution. Providing of the particular ions is largely based on the identifying desired properties of the ion (e.g., its charge and whether it has a particular bioactivity that is desired to be present in the resulting ionic liquid). Methods of identifying suitable ions are disclosed herein, for example, by considering the chemical structure and charge of the compounds and whether the ion combination will produce an ionic liquid. A particular method of selecting an ionic pair comprising a cation and an anion includes the steps of selecting a cation and selecting an anion, wherein the cation or the anion is an herbicidal active and wherein the cation and the anion are capable of forming an ionic liquid. An alternative method of selecting an ionic pair comprising a cation and an anion includes the steps of selecting a cation and selecting an anion, wherein the anion is an herbicidal active and wherein the cation and the anion are capable of forming an ionic liquid. Further described is a method of selecting an ionic pair comprising a cation and an anion, comprising selecting a cation selected from the group consisting of a quaternary ammonium cation and a phosphonium cation and selecting an anion, wherein the anion is selected from the group consisting of 3,6-dichloro-2-methoxybenzoate, 2-(4-chloro-2-methylphenoxy)propionate, or 2-((phosphonomethyl)amino)acetate.

In some examples, the cation is selected from the group consisting of didecyldimethylammonium, benzalkonium, hexadecyltrimethylammonium, diallyldimethylammonium, trioctylmethylammonium, tetraoctylphsophonium, cocoalkyltrimethylammonium, dicocoalkyldimethylammonium, and cocoalkyldi-(2-hydroxyethyl)methylammonium and the anion is 2-(4-chloro-2-methylphenoxy)propionate. In other examples, the cation is selected from the group consisting of didecyldimethylammonium, benzalkonium, dodecyldimethylphenoxyethylammonium, tallowalkyldipolyoxyethylene(15)-methylammonium, tetrabutylphosphonium, cocoalkyldi-(2-hydroxyethyl)methylammonium, cocoalkyltrimethylammonium, di(hydrogenated tallow)dimethylammonium, soyatrimethylammonium, cocotrimethylammonium, dicocoalkyldimethylammonium, myristyltrimethylammonium, dioctadecyldimethylammonium, didodecyldimethylammonium, and (2-hydroxyethyl)trimethylammonium and the anion is 3,6-dichloro-2-methoxybenzoate. In still further examples, the cation is (2-chloroethyl)trimethylammonium, benzalkonium, didecyldimethylammonium, di(hydrogenated tallow) dimethylammonium, (hydrogenated tallow)trimethylammonium, diallyldimethylammonium, choline, tetrabutylphosphonium, tetrabutylammonium, tetraethylammonium, and hexadecyltrimethylammonium and the anion is 2-((phosphonomethyl)amino)acetate.

Further, when preparing a composition as disclosed herein, molecular asymmetry can be particularly desired. Low-symmetry cations and anions typically reduce packing efficiency in the crystalline state and lower melting points.

Once the desired ions are provided, the ions can be combined to form the disclosed ionic liquids. There are generally two methods for preparing an ionic liquid: (1) metathesis of a salt of the desired cation (e.g., a halide salt) with a salt of the desired anion (e.g., transition metal, like Ag, salt, Group I or II metal salt, or ammonium salt). Such reactions can be performed with many different types of salts; and (2) an acid-base neutralization reaction. Another method for forming the disclosed ionic liquid compositions involves a reaction between a salt of a desired cation, say Cation X where X is an appropriate balancing anion (including, but not necessarily, a halide), and an acid to yield the ionic liquid and HX byproduct. Conversely, the disclosed ionic liquid compositions can be formed by reacting a salt of a desired anion, say Y Anion where Y is an appropriate balancing cation, with a base to yield the ionic liquid and Y base byproduct.

For example, 3,6-dichloro-2-methoxybenzoic acid, 2-(4-chloro-2-methylphenoxy)propionic acid, or N-(phosphonomethyl) glycine can be treated with sodium or potassium hydroxide used in a molar ratio of from 0.7-3 to from 0.8-5, in an aqueous environment at a temperature from 273 to 373K, e.g., 325K. The product, in the form of the sodium or potassium salt of 3,6-dichloro-2-methoxybenzoic acid, 2-(4-chloro-2-methylphenoxy)propionic acid, or N-(phosphonomethyl) glycine can then undergo a reaction with the halide salt of a cation as described herein in the molar ratio of 1:0.7 to 1:1.5. Often during the reaction, the product can precipitate as a separate phase (lower or upper layer). In the case of phase separation, the aqueous layer can be removed and the residue, which is the product, can be washed with water several times and dried. However, if there is no phase separation, organic solvent can be used for the extraction of product from water, preferably chloroform or ethyl acetate. After extraction and combining of the organic phase the solvent can be evaporated under reduced pressure and after drying a finished product is obtained as salts of the cations described here and anions of 3,6-dichloro-2-methoxybenzoic acid, 2-(4-chloro-2-methylphenoxy)propionic acid, or N-(phosphonomethyl) glycine. However, if the product is not soluble in organic solvent but soluble in water, the water can be completely evaporated, and the organic solvent (preferably acetone or ethanol) can be used to dissolve the reaction product. During this process reaction byproducts, preferably inorganic salts, can precipitate. After filtration of byproducts, the solvent can be evaporated under vacuum and the salt of the cations described herein and the anions of 3,6-dichloro-2-methoxybenzoic acid, 2-(4-chloro-2-methylphenoxy)propionic acid, or N-(phosphonomethyl) glycine can be obtained after drying.

Alternatively, the salts of the cations described herein and anions of 3,6-dichloro-2-methoxybenzoic acid, 2-(4-chloro-2-methylphenoxy)propionic acid, or N-(phosphonomethyl) glycine can be prepared by alternative procedure. A solution (preferably an aqueous or alcohol solution) of halide salts (e.g., chlorides, bromides or iodides) of the cations described herein can undergo anion exchange reactions with anion exchange resin (preferably on anion exchange column), to produce the cations with anions Off. Afterwards, neutral acids (either neat or in solution) 3,6-dichloro-2-methoxybenzoic acid, 2-(4-chloro-2-methylphenoxy)propionic acid, or N-(phosphonomethyl) glycine can be added to form hydroxides of the cations described herein (either neat or in solution), in a molar ratio from 1:0.7 to 1:1.5 at temperatures from 0 to 100° C.

After reaction, the excess of reactants can be filtered and the water can be evaporated under reduced pressure and after drying new salts of the cations described herein and the anions of 3,6-dichloro-2-methoxybenzoic acid, 2-(4-chloro-2-methylphenoxy)propionic acid, or N-(phosphonomethyl) glycine can be isolated.

The salts of the cations described herein anions of 3,6-dichloro-2-methoxybenzoic acid, 2-(4-chloro-2-methylphenoxy)propionic acid, or N-(phosphonomethyl) glycine yet can be prepared by alternative procedure. 3,6-Dichloro-2-methoxybenzoic acid, 2-(4-chloro-2-methylphenoxy)propionic acid, or N-(phosphonomethyl) glycine; sodium or potassium hydroxide; and halide salts of the cations described herein used in a molar ratio of from 0.7 to 3: from 0.8 to 5: from 0.8 to 5 can be placed in an aquatic environment at a temperature from 273 to 373K, e.g., 325K. The reaction mixture can be stirred and heated for 1 hour to 24 hours. After cooling, the mixture can be extracted by organic solvent (preferably chloroform or ethylacetate). The organic layer can then be washed several times with distilled water. The aqueous phases can be tested for the presence of chloride ion using silver nitrate solution. Finally, the organic solvent can be removed and the product can be dried.

Many of the bioactive compounds (e.g., herbicidal actives, pesticidal actives, etc.) disclosed herein are cationic or can be made cationic, the identification of which can be made by simple inspection of the chemical structure as disclosed herein. Further, many of these compounds are commercially available as their halide salts or can be converted to their halide salts by reactions with acids (e.g., HF, HCl, HBr, or HI) or by treating a halogenated compound with a nucleophile such as an amine. Further many of the anions disclosed herein are commercially available as metal salts, Group I or II metal salts, or ammonium salts. Combining such cations and anions in a solvent with optional heating can thus produce the ionic liquid compositions. For a review of the synthesis of ionic liquids see, for example, Welton, Chem Rev 1999, 99:2071-2083, which is incorporated by reference herein for at least its teachings of ionic liquid synthesis.

Ionic liquids which are immiscible with water are often conveniently prepared by the combination of aqueous solutions of two precursor salts, each of which contains one of the two requisite ions of the targeted ionic liquids. On combination, the desired salt forms a separate phase from the aqueous admixture. Such phases are readily washed free of byproduct salts with additional water, and can subsequently subjected to other procedures (e.g., as disclosed in the Examples) to separate them from non-water soluble impurities.

The purification of ionic liquids can be accomplished by techniques familiar to those skilled in the art of organic and inorganic synthesis, with the notable exception of purification by distillation of the ionic liquid. In some cases, ionic liquids can be purified by crystallization at appropriate conditions of temperature and pressure (e.g., at low temperature and pressure). Such techniques can include the use of a solvent from which the ionic liquid can be crystallized at an appropriate temperature.

### E. Methods of Use of the Compositions

U.S. Published Application 2008/0207452 to Kramer et al. describes compositions derived from herbicidal carboxylic acids and certain trialkylamines, pyrrolidines, and heteroarylamines.

The disclosed compositions have many uses. For example, the disclosed compositions can be used to allow fine tuning and control of the rate of dissolution, solubility, and bioavailability, to allow control over physical properties and mechanical strength, to improve homogenous dosing, and to allow easier formulations. The disclosed compositions also make having compositions with additional functionality possible.

Converting an active herbicidal compound into an ionic liquid by introducing a second ion, or by providing such a combination of ions in solution, allows for enhancement of plant penetration and thus for improvement of delivery. These compositions can increase herbicidal performance due to new penetration mechanisms into the plant tissue. For example, cations with recognized surface and transport properties can be paired with the herbicidal anions described herein resulting in intensified uptake and translocation of the active compound.

The fact that the compositions are composed of cations and anions that form or can form an ionic liquid allows the tuning of hydrophilicity and hydrophobicity (among other properties), and thus control of surface wetting. The presence of a surfactant cation in an herbicidal composition alters the surface properties of the droplet, improves spreading and retention time, and changes the diffusion coefficient of the herbicide and its mobility. Additionally, the combination of two or more active chemicals in a single entity can reduce the number of additional chemicals such as adjuvants or surfactants required per application.

The compositions described herein are designed with dual functionality where both cation and anion add to the beneficial properties of the salt. In addition, secondary biological functions are introduced into the same herbicidal compound, where the broad spectrum of antimicrobial and fungicidal activity of the cations adds to the herbicidal activity. Moreover, if the herbicidal activity of the disclosed compositions is even only equivalent to the commercial products, the mass (weight %) of active ingredient can be reduced.

Converting an active herbicidal compound into an composition as dislosed herein allows at least for retaining the desired herbicidal activity, while the surface and physicochemical properties are modified. Therefore, control of solubility, reduction of volatility and drift during application and use, and reduced soil and groundwater mobility can be observed. As a result, herbicidal compositions can be applied less frequently, stay on the plant leaves longer, and therefore reduce the need for repeat applications.

In the long-term, these herbicidal compositions can be advantageous to the consumers both economically and environmentally. Ion pairing of ionic liquids even when dissolved (in contrast to known high melting metal salt forms), suggests that pairing herbicides with penetration enhancers (e.g., fatty quaternary ammoniums) will result in faster plant penetration. The antibacterial and/or antifungal activity of the chosen cations can offer additional advantages. In addition, the compositions described herein provide dual biological functionality in one compound. For instance, the antibacterial/antifungal activity of the chosen cations can offer additional advantages in plant protection. Further, the synthesized compounds described herein have ionic structures, are not volatile, and their vapor pressure at moderate temperatures is practically immeasurable. This reduces or eliminates volatilization during and after application, thereby reducing the contamination of non-target plants and reducing worker exposure. The long alkyl chains of the cations cause the products to have surfactant properties thus no additional surfactant is needed. In addition, the pairs of ion-containing anion of 2-(4-chloro-2-methylphenoxy) propionate, for example, depending on the type of cation salts, can be hydrophobic or hydrophilic. By changing the cation in the resulting salts, the hydrophobicity and hydrophilicity can be tuned. The chosen cations can decrease the water solubility of herbicides. Long alkyl chains on the cations can cause the products to exhibit surface activity. These hydrophobic compositions can stay on the plant leaves longer, thus reducing repeat plant treatment, and soil and groundwater mobility.

Other uses for the compositions include providing herbicides with high thermal and chemical stabilities and often glass transitions below room temperature. Further, these compounds don't react with metals and have no tendency to be adsorbed in soil (Due to lack of carboxylic group). The compositions described herein are odorless, have an improved ease of use and manufacture, and possess antielectrostatic properties due to the long alkyl chains on the product cations.

A further use for the compositions described herein includes the treatment of seeds. As used herein, “seed” includes the seed of a native plant, hybrid plant, transgenic plant, genetically modified plant, or a combination of these. In some embodiments, the treatment of seeds with one or more of the compositions described herein can impart heribicidal properties to the seeds and the resulting plant's roots and shoots. The seeds can be treated according to methods known to those of skill in the art, including, for example, seed dressing, seed coating, seed dusting, seed soaking, and seed pelleting. In some embodiments, the compositions described herein can be coated on the surface of the seed and/or can penetrate into the seed.

The compositions disclosed herein that contain ionic herbicidal and pesticidal actives can be used in the same way as the actives themselves.

### Administration and Delivery

Formulations for administration can include sprays, liquids, and powders. The disclosed compositions having hydrophobic ions can be particularly useful in such applications because they can adhere to the surface longer when exposed to water or other fluids than would a similar hydrophilic salt. Likewise, compositions comprising herbicide or pesticide ions and hydrophobic counterions can be expected to resist erosion from rainfall. It should also be noted that pesticides or herbicides applied to plant leaves can be less prone to be lost by rain even if it follows application.

When one or more ions in the disclosed compositions are herbicidal actives, an effective amount of the composition can be administered to an area to control plants. Techniques for contacting such surfaces and areas with the disclosed compositions can include, spraying, coating, dipping, immersing, or pouring the composition into or onto the surface or area. The precise technique will depend on such factors as the type and amount of infestation or contamination, the size of the area, the amount of composition needed, preference, cost, and the like. Similarly, when one or more ions in the disclosed compositions are a pesticidal active, an effective amount of the composition can be administered to an area to control pests. When one or more ions in the disclosed compositions are an antibacterial, an effective amount of the composition can be contacted (i.e., administered) to any surface that has bacteria.

The disclosed compositions can be dissolved in a suitable solvent or carrier as are disclosed herein. This method can enhance the delivery of one or more active ions in the composition. Further, as is disclosed herein, this method can create a synergistic effect among the various ions present. While not wishing to be bound by theory, the dissociation coefficient of various ions in an ionic liquid can be different in different solvents. Thus, ions in an ionic liquid can dissociate freely in one solvent and cluster in another. This phenomenon can be utilized to provide formulations of compounds that are difficult to deliver (e.g., decrease the water solubility of herbicides and increase the penetration into the leaf). That is, compounds can be formed into an ionic liquid, as described herein, and then dissolved in a suitable solvent to provide an easily deliverable solution. A synergistic effect can be observed upon administration to a subject, when ions cluster and act together, rather than independently.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions. All chemicals used were of analytical grade, purchased from Sigma-Aldrich (Milwaukee, Wis.), and used without further purification unless otherwise noted.

### Example 1

### Mecoprop-P Ionic Liquids

### A. Synthesis

Example I. Didecyldimethylammonium (+)-(R)-2-(4-chloro-2-methylphenoxy)propionate [DDA][MCPP-P] To a round-bottom reaction flask (100 mL) equipped with a magnetic stirrer was introduced 0.025 mol of (+)-(R)-2-(4-chloro-2-methylphenoxy)propionic acid in 30 mL of distilled water. To the mixture was added 10% aqueous KOH and the resultant mixture was stirred. The reaction was conducted at 343K until the solution became homogeneous. Then an equimolar amount of didecyldimethylammonium chloride was added to provide a water-soluble product. After 24 hours, the product was isolated by dissolving it in 30 mL of chloroform and washing with distilled water from the unreacted substrate and byproduct KCl. The aqueous layer was separated from the organic layer, the organic layer was evaporated, and the residue was dried for 24 hours at 323K under reduced pressure to produce didecyldimethylammonium (+)-(R)-2-(4-chloro-2-methylphenoxy)propionate in liquid form with a yield of 94%. The structure was confirmed using ¹H/¹³C nuclear magnetic resonance. ¹H NMR (CDCl₃) δ ppm=0.88 (t, J=6.7 Hz, 6H), 1.26 (m, 32H), 1.56 (d, J=6.6 Hz, 3H), 2.23 (s, 3H), 3.01 (s, 6H), 3.08 (t, J=5.5 Hz, 4H), 4.46 (q, J=6.8 Hz, 1H), 6.78 (d, J=8.8 Hz, 1H), 7.01 (dd, J^{1.2}=2.5 Hz, J^{2.3}=6.0 Hz, 1H), 7.03 (d, J=0.6 Hz, 1H); ¹³C NMR δ ppm=14.0, 16.4, 19.3, 22.4, 22.5, 26.1, 29.05, 29.14, 29.27, 29.32, 31.7, 51.2, 63.1, 76.0, 113.2, 123.7, 125.9, 128.6, 129.8, 155.9, 177.0. Elemental analysis C₃₂H₅₈ClNO₃: calculated C=71.14%, H=10.82%, N=2.59%, observed: C=70.81%, H=11.03%, N=2.42%. Glass Transition: 221K, T onset_{t(5%)}=463K, 501K.

Example II. Benzalkonium (±)-2-(4-chloro-2-methylphenoxy)propionate-[BA][MCPP] A 10% aqueous solution of NaOH (0.055 mol) was added dropwise to a suspension of 0.05 mole of (±) -2-(4-chloro-2-methyl-phenoxy)propionic acid in 40 mL of distilled water, The reaction was conducted at 313K for 30 minutes. Then a stoichiometric amount of benzalkonium chloride in 30 mL of distilled water was added. The product precipitated from the solution in the form of a lower liquid layer. Then, to the reaction, 30 mL of chloroform was added and the phases were separated. The organic phase was washed with distilled water until the aqueous layer contained no chloride ions. The chloroform was evaporated and the product dried at 333K under vacuum. Yield 93%, purity 99%. ¹H NMR (CDCl₃) δ ppm=0.88 (t, J=7.1 Hz, 3H), 1.26 (m, max 22H), 1.59 (d, J=6.9 Hz, 3H) 1.63 (kw, J=3.9 Hz, 2H), 2.17 (s, 3H), 3.03 (s, 6H), 3.17 (t, J=4.3 Hz, 2H), 4.48 (kw, J=6.8 Hz, 1H), 4.62 (s, 2H), 6.80(d, J=8.5 Hz, 1H), 6.88 (dd, J^{1.2}=2.8 Hz, J^{2.3}=6.0 Hz, 1H), 6.96 (d, J=0.6 Hz, 1H), 7.40 (d, J=1.7 Hz, 2H), 7.43 (t, J=4.8 Hz, 1H), 7.45 (t, J=1.7 Hz, 2H); ¹³C NMR δ ppm=14.0, 16.3, 19.4, 22.5, 22.6, 26.1, 29.09, 29.16, 29.19, 29.24, 29.30, 29.42, 29.47, 29.51, 31.7, 49.4, 63.0, 67.1, 76.3, 113.1, 123.5, 125.8, 127.4, 128.3, 128.9, 129.6, 130.4, 132.9, 156.0, 176.8. Glass transition 244K, T_{onset(5%)}=466K, 536K.

Example III. Domiphen (+)-(R)-2-(4-chloro-2-methylphenoxy)propionate—[DOM][MCP-P] To a suspension of 0.045 mol (+)-(R)-2-(4-chloro-2-methylphenoxy) propionic acid in 40 mL of distilled water was added 10% aqueous solution of KOH dropwise. The mixture was heated to a temperature of 313K. A stoichiometric amount of domiphen bromide was added to the resultant clear solution and the reaction mixture was stirred for 24 hours. A two-layer mixture formed as a result of reaction and the product precipitated in the form of the lower layer. Chloroform (40 mL) was added and the layers were separated. The organic phase was washed with deionized water until the bromide ions were no longer present. The chloroform was evaporated and the residue dried at 353K under vacuum. Yield 99%, purity 99%. ¹H NMR (CDCl₃) δ ppm=0.88 (t, J=6.7 Hz, 3H), 1.26 (m, 18H), 1.59 (d, J=6.9 Hz, 3H), 1.69 (kw, J=6.9 Hz, 2H), 2.21 (s, 3H), 3.27 (s, 6H), 3.39 (t, J=4.3 Hz, 2H), 4.01 (t, J=8.4 Hz, 2H), 4.30 (t, J=4.0 Hz, 2H), 4.46 (kw, J=6.7 Hz, 1H), 6.82 (d, J=8.5 Hz, 1H), 6.84 (d, J=1.1 Hz, 2H), 6.87 (t, J=5.6 Hz, 1H), 7.01 (dd, J^{1.2}=0.6 Hz, J^{2.3}=2.2 Hz, 1H) 7.02 (d, J=0.8 Hz, 1H), 7.31 (t, J=1.7 Hz, 2H); ¹³C NMR δ ppm=14.0, 16.3, 19.4, 22.5, 22.7, 26.1, 29.07, 29.16, 29.24, 29.31, 29.41, 29.43, 31.7, 51.4, 61.87, 61.92, 65.6, 76.5, 113.2, 114.1, 122.0, 123.6, 125.8, 128.41, 128.44, 129.7, 156.1, 156.8, 176.7. Elemental analysis: C₃₂H₅₀ClNO₄: calculated C=70.11%, H=9.19%, N=2.55%, observed: C=69.79%, H=8.99%, N=2.67%. Glass transition: 239K, T_{onset(5%)}=459K, 514K.

Example IV. 1-Hexadecylpirydinium (+)-(R)-22-(4-chloro-2-methylphenoxy)propionate—[C16PIR][MCPP-P] Potassium (+)-(R)-2-(2-(4-chloro-2-methylphenoxy)propionate (0.033 mol) was added to 0.03 mol of 1-hexadecylpirydinium chloride in acetone at a temperature of 293K. Then the reaction mixture was stirred vigorously for 30 minutes and then stirred for an additional hour at temperature of 293K. The acetone was removed under vacuum and anhydrous acetone (30 mL) was added. The precipitate was filtered and the filtrate concentrated in a vacuum evaporator. The product was dried at 333K under vacuum. Yield 99%. The structure of the newly formed salt was confirmed by NMR. ¹H NMR (CDCl₃) δ ppm=0.88 (t, J=6.6 Hz, 3H), 1.25 (m, 26H), 1.57 (d, J=6.9 Hz, 3H), 1.85 (kw, J=6.6 Hz, 2H), 2.19 (s, 3H), 4.46 (kw, J=6.7 Hz, 1H), 4.62 (t, J=7.4 Hz, 2H), 6.77 (d, J=8.5 Hz, 1H), 6.89 (dd, J^{1.2}=2.7 Hz, J^{2.3}=6.0 Hz, 1H), 6.98 (d, J=2.5 Hz, 1H), 7.90 (t, J=6.9 Hz, 2H), 8.29 (t, J=7.7 Hz, 1H), 9.09 (d, J=5.8 Hz, 2H); ¹³C NMR δ ppm=13.9, 16.2, 19.3, 22.5, 25.9, 28.9, 29.13, 29.20, 29.34, 29.40, 29.44, 29.47, 31.2, 31.5, 31.7, 61.7, 76.1, 113.1, 123.6, 125.8, 128.1, 128.3, 129.7, 144.6, 144.7, 155.8, 177.0. Elemental analysis C₃₁H₄₈ClNO₃ calculated: C=71.86%, H=9.34%, N 2.70%, observed: C=72.21%, H=9.03%, N=2.99%. Glass transition 236K, cryst: 255K, mp: 263K, Tₒₙₛₑₜ(₅%)=548K, 582K, 639K, 705K.

Example V. Hexadecyltrimethylammonium (±)-2-(4-chloro-2-methylphenoxy)propionate—[CTA][MCPP] Hexadecyltrimethylammonium bromide (0.025 mol) was dissolved in 40 mL of distilled water. Then the sodium salt of (±)-2-(4-chloro-2-methylphenoxy)propionic acid, prepared beforehand by mixing 0.025 mol of acid (±)-2-(4-chloro-2-methylphenoxy)propionic acid with an aqueous solution of NaOH at a temperature of 323K, was added. The mixture was stirred for 2 hours and a water-soluble product was obtained and extracted with chloroform. After separating the layers (the orange color of the lower layer indicated that the product had passed to the chloroform layer), the chloroform was evaporated. The product was dried under vacuum at 333K for 24 hours. Yield 85%. The structure of the salt was confirmed by proton and carbon NMR: ¹H NMR (CDCl₃) δ ppm=0.88 (t, J=6.7 Hz, 3H), 1.26 (m, 26H), 1.41 (kw, J=7.4 Hz, 2H), 1.54 (d, J=6.6 Hz, 3H), 2.21 (s, 3H), 3.04 (s, 9H), 3.10 (t, J=4.3 Hz, 2H), 4.41 (kw, J=6.7 Hz, 1H), 6.76 (d, J=8.5 Hz, 1H), 7.01 (dd, J^{1.2}=2.2 Hz, J^{2.3}=6.3 Hz, 1H), 7.03 (d, J=2.5 Hz, 1H); ¹³C NMR δ ppm=14.0, 16.3, 19.3, 22.6, 22.9, 26.1, 29.14, 29.24, 29.33, 29.41, 29.51, 29.54, 29.56, 29.58, 31.8, 52.8, 66.5, 76.1, 113.2, 123.7, 126.0, 128.6, 129.8, 155.9, 176.9. Elemental analysis C₂₉H₅₂ClNO₃ calculated: C=69.92%, H=10.52%, N=2.81%, observed: C=70.17%, H=10.90%, N=2.72%. Glass transition 237K, Temp cryst: 251K, mp: 279K, T_{decomp} T_{onset(5%)}=489K, 525K, 589K, 618K.

Example VI. 3-Butyl-1-methylitnidazolium (+)-(R)-2-(4-chloro-2-methylphenoxy)propionate [C4IM][MCPP-P] Into a 100 mL round bottom flask equipped with a magnetic stirrer was added 0.06 mol of (+)-(R)-2-(4-chloro-2-methylphenoxy)propionic acid dissolved in 20 mL of distilled water at 333K. Then, 0.066 mol of an aqueous solution of NaOH was added. When the solution became clear, 0.06 mole of 3-butyl-1-methylimidazolium bromide was added in 10 mL of water. The reaction proceeded for 24 hours at 323K. The reaction mixture was then evaporated and 30 mL of anhydrous acetone was added to the residue.

Sodium bromide was separated by filtration and the filtrate solvent was evaporated on a rotary evaporator. The product was dried under reduced pressure at a temperature of 333K. Yield 99%. ¹H NMR (DMSO-d₆) δ ppm=0.88 (t, J=7.3 Hz, 3H), 1.24 (sex, J=7.4 Hz, 2H), 1.41 (d, J=6.8 Hz, 3H), 1.72 (q, J=5.5 Hz, 2H), 2.12 (s, 3H), 3.84 (s, 3H), 4.15 (t, J=7.1 Hz, 2H), 4.24 (q, J=6.7 Hz, 1H), 6.73 (d, J=8.8 Hz, 1H), 7.02 (d, J=2.8 Hz, 1H), 7.10 (s, 1H), 7.77 (d, J=1.7 Hz , 1H), 7.84 (d, J=1.3 Hz, 1H), 9.65 (s, 1H); ¹³C NMR δ ppm=13.3, 16.0, 18.8, 19.3, 31.5, 35.6, 48.4, 76.0, 113.4, 122.2, 122.3, 123.6, 125.8, 127.8, 129.3, 137.2, 156.0, 173. 9. Elemental analysis C₁₈H₂₅ClN₂O₃ calculated: C=61.27%, H=7.14%, N=7.94%, observed: C=61.56%, H=6.89%, N=8.32%. Glass transition 234K, Mp: 267K, Tₒₙₛₑₜ=525, 543K.

Example VII. 1-Butyl-1-methylmorpholinium (±)-2-(4-chloro-2-methylphenoxy)propionate—[C4MOR][MCPP] Into a 100 mL round-bottomed flask was added 0.065 mol of 1-butyl-1-methylmorpholinium bromide dissolved in 40 mL of methanol followed by 0.07 mol of sodium (±)-2-(4-chloro-2-methylphenoxy)propionate. The reaction was carried out for 12 hours. Then methanol was evaporated under vacuum, the residue was dissolved in anhydrous acetone, and the precipitated inorganic salt was filtered out. After the acetone was concentrated down, the product was dried under reduced pressure at a temperature of 323K. Yield 99%. ¹H NMR (DMSO-d₆) δ ppm=0.94 (t, J=7.4 Hz, 3H), 1.31 (sex, J=7.4 Hz, 2H), 1.42 (d, J=6.7 Hz, 3H), 1.67(q, J=4.0 Hz, 2H), 2.15 (s, 3H), 3.19 (s, 3H), 3.49 (t, J=6.4 Hz, 2H), 3.55 (t, J=8.5 Hz, 4H), 3.93 (t, J=2.6 Hz, 4H), 4.32 (kw, J=6.7 Hz, 1H), 6.74 (d, J=8.8 Hz, 1H), 7.06 (d, J=8.7 Hz, 1H), 7.12 (s,1H); ¹³C NMR δ ppm=13.6, 16.0, 19.19, 19.21, 22.8, 46.0, 58.9, 59.9, 63.5, 75.4, 113.5, 122.6, 125.9, 128.0, 129.4, 155.8, 174.9. Elemental analysis C₁₉H₃₀ClNO₄: calculated: C=61.36%, H=8.13%, N=3.77%, observed: C=61.53%, H=7.99%, N=3.75%. Tₒₙₛₑₜ=496, 506K.

Example VIII. 1-Butyl-1-methylpyrrolidinium (+)-(R)-2-(4-chloro-2-methylphenoxy)propionate—[C4MOR][MCPP-P] Into a round-bottom reaction flask (100 mL) equipped with a magnetic stirrer was introduced 0.025 mol of (+)-(R)-2-(4-chloro-2-methylphenoxy)propionic acid in 30 mL of distilled water. Aqueous KOH (10%) was added and the mixture was stirred to obtain potassium (+)-(R)-2-(4-chloro-2-methylphenoxy)propionate. The aqueous solution of potassium (+)-(R)-2-(4-chloro-2-methylphenoxy)propionate was added to an aqueous solution of 1-butyl-1-methylpyrrolidinium bromide. The reaction was carried out overnight and then the product was extracted with ethyl acetate. The organic layer was washed several times with distilled water to remove the KBr byproduct, and then the solvent was evaporated on a rotary evaporator. The product was dried in a vacuum desiccator over P₂O₅. Yield 99%. NMR spectra are described below. ¹H NMR (DMSO-d₆) δ ppm=0.91 (t, J=7.3 Hz, 3H), 1.30 (sex, J=7.4 Hz, 2H), 1.40 (d, J=6.6 Hz, 3H), 1.65 (q, J=4.1 Hz, 2H), 2.08 (q, J=8.1 Hz, 4H), 2.13 (s, 3H), 2.99 (s, 3H), 3.33 (t, J=4.3 Hz, 2H), 3.47 (t, J=2.3 Hz, 4H), 4.27 (q, J=6.7 Hz, 1H), 6.71 (d, J=8.8 Hz, 1H), 7.05 (d, J=8.7 Hz, 1H), 7.11 (s, 1H); ¹³C NMR δ ppm=13.6, 16.1, 19.3, 19.4, 21.1, 25.1, 47.5, 62.9, 63.4, 75.7, 113.6, 122.6, 125.9, 128.1, 129.4, 156.0, 175.0. Elemental analysis C₁₉H₃₀ClNO₃: C=64.12%, H=8.50%, N=3.94%, observed: C=64.02%, H=8.80%, N=4.01%. Glass transition 255K, Mp: 264K Tₒₙₛₑₜ=516, 530, 580, 637K.

Example IX. 1-Decyloxymethyl-8-hydroxquinolinium (±)-2-(4-chloro-2-methylphenoxy)propionate—[OC10CHIN][MCPP] In a round-bottom reaction flask (100 mL) equipped with a magnetic stirrer were mixed 0.01 mol of (+)-(R)-2-(4-chloro-2-methylphenoxy)propionic acid in 30 mL of distilled water and an equimolar amount of 10% aqueous KOH to obtain potassium (+)-(R)-2-(4-chloro-2-methylphenoxy)propionate. The mixture was heated at 323K until a homogeneous solution was formed. Then a stoichiometric amount of 1-decyloxymethyl-8-hydroxquinolinium chloride was added (dissolved in 20 mL of distilled water). The reaction product immediately began to precipitate. The product was separated via filtration, washed several times with distilled water to remove the inorganic salts, and dried at 333K under reduced pressure. The product was obtained as a yellow powder in a yield of 85%. Elemental analysis: C₃₀H₄₀ClNO₅ calculated: C=67.97%, H=7.61%, N=2.64%, observed values C=67.99%, H=7.74%, N=2.47%.

Example X. Diallyldimethylammonium (±)-2-(4-chloro-2-methylphenoxy)propionate In a round-bottom reaction flask (100 mL) equipped with a magnetic stirrer were mixed 0.01 mol of (+)-(R)-2-(4-chloro-2-methylphenoxy)propionic acid in 30 mL of distilled water and an equimolar amount of 10% aqueous KOH were mixed to obtain potassium (+)-(R)-2-(4-chloro-2-methylphenoxy)propionate. Aqueous 65% diallyldimethylammonium chloride solution was then added. The reaction mixture was stirred for 24 hours. Then water was removed from the system through evaporation under reduced pressure and the reaction mixture was diluted with anhydrous isopropanol. Potassium chloride, the precipitated byproduct, was filtered out and isopropanol was evaporated to obtain the product. The product diallyldimethylammonium (±)-2-(4-chloro-2-methylphenoxy)propionate was obtained in the form of viscous liquid in a 90% yield. CHN elemental analysis: C₁₈H₂₆ClNO₃ summary calculated values: C=63.61%, H=7.71%, N=4.12%, observed: C=63.22%, H=8.03%, N=4.29%.

Example XI. Trioctylmethylammonium (±)-2-(4-chloro-2-methylphenoxy)propionate Trioctylmethylammonium chloride, (±)-2-(4-chloro-2-methyl)propionic acid, and sodium hydroxide were added to a reaction flask in stoichiometric quantities and diluted with water. The reaction mixture was stirred vigorously at room temperature for 2 hours. The organic phase was separated in the funnel and then washed with water until the water had no chloride ions (as verified with the silver nitrate test). The reaction product was dried at 323K under vacuum for 12 hours. Trioctylmethylammonium (±)-2-(4-chloro-2-methylphenoxy)propionate was obtained in 90% yield (purity 96%).

Example XII. Tetraoctylphosphonium (+)-(R)-2-(4-chloro-2-methylphenoxy)propionate—[C8P][MCPP-P] In a three-necked reaction flask equipped with a magnetic stirrer, heating bath, a dropping funnel, reflux condenser, and thermometer was added 0.055 mol of (+)-(R)-2-(4-chlorophenoxy)propionic acid in 30 mL of distilled water. Then 0.065 mole of a 10% aqueous solution of NaOH was added dropwise. The reaction was conducted at 333K until the homogeneous solution was obtained. Then a stoichiometric amount of tetraoctylphosphonium bromide was added to the reaction mixture. A water-soluble product was obtained. The reaction mixture was extracted with ethyl acetate, the organic phase was washed with distilled water from the unreacted feedstock and sodium bromide by-product, dried, and evaporated. Finally, the product was dried for 24 hours at 323K under reduced pressure. ¹H NMR (CDCl₃) δ ppm=J=6.6 Hz, 12H), 1.27 (m, 40H), 1.42 (q, J=5.6 Hz, 8H), 1.60 (d, J=6.9 Hz, 3H), 2.20 (t, J=2.7 Hz, 8H), 2.24 (s, 3H), 4.42 (kw, J=6.7 Hz, 1H), 6.83 (d, J=8.8 Hz, 1H), 6.97 (d, J=8.8 Hz, 1H), 7.02 (s, 1H); ¹³C NMR δ ppm=13.8, 16.3, 18.3, 18.9, 19.4, 21.6 (d, J^{CP}=4.8 Hz), 22.3, 28.7, 30.6 (d, J^{CP}=14.5), 31.4, 76.5, 113.3, 123.3, 125.7, 128.1, 129.5, 156.0, 176.3. CHN elemental analysis C₄₂H₇₈ClO₃P calculated: C=72.32%, H=11.27%, observed: C=72.48%, H=11.07%. Glass transition 212K, Cryst. 263K, Tₒₙₛₑₜ=580, 623K.

Example XIII. 3-Carbamoyl-1-methylpyridinium (+)-(R)-2-(4-chloro-2-methylphenoxy)propionate Methanolic solutions of 1-methylnicotinamide chloride and potassium salt of (+)-(R)-2-(4-chloro-2-methylphenoxy)propionic acid were added to the reaction vessel. After precipitation of potassium chloride, it was filtered out from the solution and the solvent was evaporated under vacuum. The product was obtained as a white powder with a sharp melting point. The reaction proceeded with 95% yield. Elemental analysis C₁₇H₁₉ClN₂O₄ calculated values: C=58.21%, H=5.46%, N=7.99%, observed: C=57.97%, H=5.80%, N=8.12%.

Example XIV. Alkyltrimethylammonium (±)-2-(4-chloro-2-methylphenoxy)propionate Equimolar aqueous solutions of alkyltrimethylammonium chloride (alkyl substituent as coco) and sodium (±)-2-(4-chloro-2-methylphenoxy)propionate were mixed together. After 24 hours, the product was extracted with chloroform. The organic layer was washed several times with distilled water to remove the by-product NaCl. Then, chloroform was evaporated on a rotary evaporator. The product was dried at a temperature of 323K, under reduced pressure, to obtain a liquid product in 90% yield. NMR: ¹H NMR (CDCl₃) δ ppm=0.88 (t, J=6.5 Hz, 3H), 1.25 (m, max 32H), 1.53 (d, J=6.7 Hz, 3H), 2.21 (s, 3H), 2.98 (s, 9H), 3.05 (t, J=8.6 Hz, 2H), 4.41 (kw, J=7.0 Hz, 1H), 6.74 (d, J=8.2 Hz, 1H), 7.00 (d, J=2.6 Hz, 1H), 7.03 (s, 1H); ¹³C NMR δ ppm=14.1, 16.4, 19.4, 22.7, 23.0, 26.2, 27.2, 29.07, 29.25, 29.32, 29.45, 29.52, 29.61, 29.68, 31.7, 31.9, 52.9, 66.6, 76.0, 113.2, 123.7, 126.0, 128.6, 129.7, 155.7, 177.0. Glass transition: 216K, Temperature cryst: 263K, Mp: 270K, Tₒₙₛₑₜ=482, 504, 553K.

Example XV. Dialkyldimethylammonium (±)-2-(4-chloro-2-methylphenoxy)propionate Stoichiometric amounts of dialkyldimethylammonium (alkyl substituent as coco) chloride and the sodium salt of (±)-2-(4-chloro-2-methylphenoxy)propionic acid were mixed in a round bottom flask. Water was added and a mixture was stirred vigorously. The product precipitated from the system as the upper liquid layer and was extracted with added ethyl acetate. The aqueous layer was removed, and the organic layer was washed with distilled water. Finally, ethyl acetate was evaporated on a rotary evaporator. The product was obtained in a yield above 90% and dried under vacuum at elevated temperatures. NMR spectra were performed to confirm the structure. ¹H NMR (CDCl₃) δ ppm=0.88 (t, J=6.5 Hz, 6H), 1.26 (m, max 44H), 1.42 (q, J=6.9 Hz, 4H), 1.57 (d, J=6.6 Hz, 3H), 2.23 (s, 3H), 3.08 (s, 6H), 3.16 (t, J=8.4 Hz, 4H), 4.44 (kw, J=6.7 Hz, 1H), 6.80 (d, J=8.5 Hz, 1H), 6.99 (d, J=8.8 Hz, 1H), 7.03 (s, 1H); ¹³C NMR δ ppm=14.0, 16.3, 19.4, 22.4, 22.5, 26.1, 28.9, 29.03, 29.08, 29.16, 29.19, 29.22, 29.32, 29.43, 29.49, 29.53, 31.67, 31.73, 31.75, 51.0, 63.0, 76.3, 113.2, 123.5, 125.8, 128.4, 129.6, 156.0, 176.7. Glass transition 239K, Mp: 252K.

Example XVI. Esterquat (±)-2-(4-chloro-2-methylphenoxy)propionate Esterquat, sodium hydroxide, and (±)-2-(4-chloro-2-methylphenoxy)propionic acid were mixed in a round bottom flask. Water (40 mL) was added as a solvent and the mixture was stirred. The product precipitated as the lower layer and was extracted several times with chloroform and washed with water to remove inorganic salts. Then chloroform was removed under reduced pressure and the product dried at 323K under vacuum. The product was obtained as a smear in 96% yield.

Example XVII. Alkyldi(2-hydroxyethyl)methylammonium (±)-2-(4-chloro-2-methylphenoxy)propionate In a round-bottom reaction flask (100 mL) equipped with a magnetic stirrer were mixed 0.01 mol of (+)-(R)-2-(4-chloro-2-methylphenoxy)propionic acid in 30 mL of distilled water and an equimolar amount of 10% aqueous KOH to obtain potassium (+)-(R)-2-(4-chloro-2-methylphenoxy)propionate. After the solution became clear, alkyl(2-hydroxyethyl)methylammonium chloride (coco alkyl, the number of oxyethylene groups equal to 15) was added. The product was extracted with chloroform. After removal of the solvent on a rotary evaporator, the product was dried under reduced pressure at a temperature of 323K. The ionic liquid was obtained with yield above 90%. ¹H NMR (CDCl₃) δ ppm=0.88 (t, J=6.2 Hz, 3H), 1.26 (m, max 30H), 1.45 (q, J=6.9 Hz, 2H), 1.55 (d, J=6.9 Hz, 3H), 2.22 (s, 3H), 3.01 (s, 3H), 3.25 (t, J=7.7 Hz, 2H), 3.37 (t, J=5.6 Hz, 4H), 3.87 (t, J=4.4 Hz, 4H), 4.43 (q, J=6.8 Hz, 1H), 6.71 (d, J=8.8 Hz, 1H), 7.01 (d, J=8.5 Hz, 1H), 7.05 (s, 1H); ¹³C NMR δ ppm=14.0, 16.3, 19.3, 22.3, 22.6, 26.3, 27.08, 27.13, 29.13, 29.23, 29.37, 29.41, 29.51, 29.58, 31.6, 31.8, 49.8, 55.5, 63.5, 64.0, 75.8, 113.0, 124.0, 125.9, 128.8, 129.9, 155.7, 177.9. Glass transition 223K, Temperature cryst 270K, Mp 272K, Tₒₙₛₑₜ=507, 553, 628K.

Example XVIII. 2-Chloroetylotrimethylammonium (±)-2-(4-chloro-2-methylphenoxy)propionate A suspension of 0.015 mol silver (±)-2-(4-chloro-2-methylphenoxy)propionate in 50 mL of distilled water was prepared. Then 0.013 mole of 2-chloroetylotrimethylammonium chloride was dissolved in 25 mL of water and added to the suspension. After 24 hours, the precipitate was filtered by gravity, and the filtrate water completely evaporated on a rotary evaporator to obtain the product. The product was dried at a temperature of 60° C., under reduced pressure. Yield: 96%. Nuclear magnetic resonance spectra:¹H NMR (DMSO-d₆) δ ppm=1.57 (d, J=6.6 Hz, 3H), 2.19 (s, 3H), 3.19 (s, 9H), 3.81 (t, J=7.0 Hz, 2H), 4.57 (t, J=7.0 Hz, 2H), 5.07 (q, J=6.8 Hz, 1H), 6.93 (d, J=8.8 Hz, 1H), 7.17 (d, J=8.5 Hz, 1H), 7.23 (s, 1H); ¹³C NMR δ ppm=15.9, 18.2, 18.5, 52.9, 58.9, 72.1, 114.1, 124.6, 126.5, 128.9, 130.2, 154.3, 170.7. Elemental analysis C₁₅H₂₃Cl₂NO₃ calculated: C=53.58%, H=6.89%, N=4.17%, observed: C=53.65%, H=7.14%, N=4.42%.

Example XIX. 1,1-Dimethylpiperidinium (±)-2-(4-chloro-2-methylphenoxy)propionate 1,1-Dimethylpiperidinium iodide (0.06 mol) was dissolved in 200 mL of deionized water, then passed through the ion exchange column (indicating the hydroxyl anion) and directly added dropwise to a suspension of 0.065 mol of (±)-2-(4-chloro-2-methylphenoxy)propionic acid in 50 mL of water. Then the column was washed with deionized water to obtain a neutral pH and all fractions obtained from the column were added dropwise into the reaction mixture. The reaction system was stirred vigorously during the addition. After 30 minutes, the unreacted acid was filtered, and the filtrate evaporated to dryness to obtain the product. Finally, the product was dried under reduced pressure at 60° C. Yield: 93%. Nuclear magnetic resonance: ¹H NMR (DMSO-d₆) δ ppm=1.38 (d, J=6.6 Hz, 3H), 1.49 (q, J=5.9 Hz, 2H), 1.73 (q, J=5.1 Hz, 4H), 2.14 (s, 3H), 3.06 (s, 6H), 3.32 (t, J=5.9 Hz, 4H), 4.19 (q, J=6.8 Hz, 1H), 6.69 (d, J=8.8 Hz, 1H), 7.07 (d, J=8.7 Hz, 1H), 7.11 (s, 1H); ¹³C NMR δ ppm=16.1, 19.3, 19.6, 20.5, 50.7, 61.4, 76.0, 113.3, 122.3, 125.9, 127.8, 129.3, 156.1, 173.3. Elemental analysis: C₁₇H₂₆O₃NCl: calculated: C=62.27%; H=8.01%; N=4.27%; observed: C=62.61%; H=7.89%; N=4.03%. Glass transition=−31° C., Tₒₙₛₑₜ=223° C.

### B. Biological Testing

The research was conducted under controlled environmental conditions in a dedicated growth chamber. The test plant was white mustard (Sinapis alba L.). Seeds were sown into soil-filled containers equal to the depth of 1 cm. After producing first leave, only 5 plants were allowed to stay in each pot. After producing the 3rd leaf, the plants were sprayed with the ionic liquids studied using a Tee Jet 1102 sprayer, the sprayer moving above the plants at a constant speed of 3.1 m/s. The spray distance from the tips of the plant was 40 cm, the pressure of liquid in sprayer was 0.2 MPa, and a liquid in the expenditure per 1 ha was 200 L.

Examples of the ionic liquids described herein were dissolved in a solution of water and ethanol (1:2) in an amount corresponding to a concentration of 0.001 mol/L, or 0.533 g/L [DDA][MCPP-P], 0.520 g/L [BA][MCPP-P], and 0.546 g/L [DOM] [MCPP-P]. As a comparison, a commercial product containing 600 g of the herbicide Mecoprop-P in 1 L was used. After spraying the plants, the pots were placed back in a growth chamber at a temperature of 20° C. (±2° C.) and humidity of 50%. The illumination time was 16 hours per day.

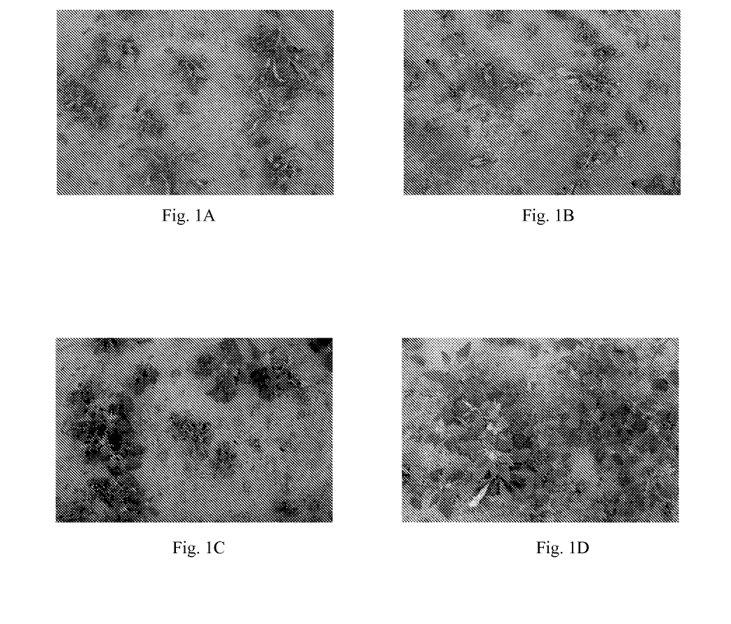

After a period of 2 weeks, the plants were cut to the soil level and weighed (0.1 g accuracy). A study was carried out in 4 replications in a completely randomized setup. The reduction of plant fresh weight as compared to control (no sprayed plants) was measured. The results are shown in Table 1 and FIG. 1.

TABLE 1
Reduction of fresh mass of White mustard (Sinapis alba)
after 2 weeks from application of herbicide

| | | Fresh mass | Reduction |
|---|---|---|---|
| | Concentra- | of white | of fresh |
| Compound | tion (M) | mustard (g) | mass (%) |
| Control (no herbicide) | — | 12.16 | 0 |
| [DDA][MCPP-P] | 0.001 | 4.78 | 60.7 |
| [BA][MCPP] | 0.001 | 5.13 | 57.8 |
| [DOM][MCPP-P] | 0.001 | 4.08 | 66.5 |
| Standard herbicide (MCPP-P) | 0.001 | 7.29 | 40.1 |

The results indicate that the new ion pairs containing anion [MCPP-P] reduce the mass of the test plant to a greater extent than the commercially available herbicide.

### Example 2

### Dicamba Ionic Liquids

### A. Synthesis

### General Procedure for Dicamba-Based Ionic Liquids:

In a round-bottom flask, equipped with a magnetic stirrer, heating bath, dropping funnel and a reflux condenser, a suspension of 0.004 mol of herbicide Dicamba (acid form) in 40 mL of distilled water was prepared. Then 0.0044 mol of 10% NaOH (aqueous) was added dropwise. The reaction was stirred at 70° C., until a completely clear solution was obtained. The heating was removed and a stoichiometric amount of the second precursor was added. After 24 hours, the product was isolated by extraction with chloroform (30 mL). The organic phase was washed with distilled water from the unreacted substrate and the byproduct inorganic salt (NaCl). In the next stage, the aqueous layer was separated from the organic layer, the organic layer was evaporated, and the product was dried 24 hours at 50° C. under reduced pressure.

Example I. Didecyldimethylammonium 3,6-dichloro-2-methoxybenzoate [DDAJ][Dicamba] In a round-bottom flask, equipped with a magnetic stirrer, heating bath, dropping funnel, and a reflux condenser, a suspension of 0.02 mol of 3,6-dichloro-2-methoxybenzoic acid in 30 mL of distilled water, was prepared. Then 0.02 mol of 10% aqueous solution of NaOH was added to the suspension. The reaction was conducted at 50° C. until the all acid reacted and a homogeneous reaction mixture was obtained. Then a stoichiometric amount of didecyldimethylammonium chloride was added in a 1 to 1 (50%:50%) water and isopropanol mixture. The product precipitated from the reaction mixture in the form of a lower liquid layer. After 24 hours, the product was isolated by separating the phases. The organic phase was washed with distilled water from the unreacted substrate and the NaCl. In the final stage the product was dried for 24 hours at 50° C. under reduced pressure. The yield is 90%. ¹H NMR (CDCl₃) δ ppm=0.88 (t, J=6.7 Hz, 6H), 1.25 (m, 28H), 1.61 (q, J=6.8 Hz, 4H), 3.34 (s, 6H), 3.39 (t, J=6.3 Hz, 4H), 3.95 (s, 3H), 6.99 (d, J=8.5 Hz, 1H), 7.08 (d, J=8.5 Hz, 1H); ¹³C NMR δ ppm=14.0; 22.5; 26.1; 29.1; 29.25; 29.27; 31.7; 50.9; 61.5; 63.1; 125.3; 125.9; 127.0; 127.8; 140.2; 151.7; 167.9. Elemental analysis CHN C₃₀H₅₃O₃NCl₂: calculated C 65.90; H 9.79; N 2.56; observed: C 65.62; H 9.65; N 2.33. DSC: T glass -47° C., mp 86° C., T_{onset 5%}=178° C.; Tₒₙₛₑₜ=232° C.

Example II. Benzalkonium 3,6-dichloro-2-methoxybenzoate To the reaction flask (100 mL) fitted with a magnetic stirrer, 0.015 mol of 3,6-dichloro-2-methoxybenzoic acid in 20 mL of distilled water was introduced. Then 10% aqueous solution of NaOH (1.5 fold molar excess) was added dropwise. The reaction was conducted at 50° C. until a clear solution was obtained. Then 0.015 mol benzalkonium chloride was dissolved in 20 mL of distilled water and added to the reaction mixture. The product was precipitated from the solution in the form of lower liquid layer. The organic phase (lower layer) was separated and washed with distilled water until the disappearance of chloride ions in the effluent. The product was dried at 50° C. under reduced pressure. A yellow, viscous liquid with yield of 92% was obtained. Nuclear magnetic resonance: ¹H NMR (CDCl₃) δ ppm=0.88 (t, J=6.7 Hz, 3H), 1.26 (m, 20H), 1.71 (q, J=6.8 Hz, 2H), 3.22 (s, 6H), 3.34 (t, J=4.3 Hz, 2H), 3.92 (s, 3H), 4.86 (s, 2H), 6.99 (d, J=8.5 Hz, 1H), 7.09 (d, J=8.8 Hz, 1H), 7.38 (d, J=6.3 Hz, 2H), 7.41 (t, J=2.8 Hz, 1H), 7.55 (t, J=3.9 Hz, 2H); ¹³C NMR δ ppm=14.0; 22.6; 22.7; 26.1; 29.1; 29.21; 29.24; 29.29; 29.34; 29.47; 29.52; 29.56; 31.8; 49.6; 61.6; 63.2; 67.4; 125.4; 126.0; 127.4; 127.6; 127.9; 129.0; 130.4; 133.1; 139.8; 151.8; 168.3. T_{onset 5%}=175° C.; Tₒₙₛₑₜ=236° C.

Example III. Dodecyldimethylphenoxyethylammonium 3,6-dichloro-2-methoxybenzoate To a reaction flask, 0.025 mol domiphen bromide dissolved in 40 mL of distilled water was placed. Then, 0.0025 mol of previously prepared sodium 3,6-dichloro-2-methoxybenzoate in 20 mL of water was added under continuous stirring. Immediately after mixing the reactants, the product was precipitated as the lower organic layer. The upper phase (water) was removed and the bottom layer was washed with water until disappearance of chloride ions in the effluent. Then the product was dried under reduced pressure at 60° C. for 24 hours. Yield 99.5%. Nuclear magnetic resonance: ¹H NMR (CDCl3) δ ppm=0.88 (t, J=6.7 Hz, 3H), 1.25 (m, 18H), 1.75 (q, J=6.8 Hz, 2H), 3.44 (s, 6H), 3.55 (t, J=8.4 Hz, 2H), 3.94 (s, 3H), 4.18 (t, J=6.5 Hz, 2H), 4.43 (t, J=6.6 Hz, 2H), 6.88 (d, J=7.7 Hz, 2H), 7.00 (d , J=8.5 Hz, 1H), 7.07 (d, J=5.2 Hz, 1H), 7.26 (t, J=2.2 Hz, 2H), 7.29 (t, J=3.4 Hz, 1H) ¹³C NMR δ ppm=14.1, 22.6, 22.9, 26.16, 26.19, 29.2, 29.33, 29.38, 29.49; 29.50, 31.8, 51.7, 61.6, 62.0, 62.1, 65.6, 114.1, 121.8, 125.3, 125.9, 127.1, 127, 7, 129.6, 140.0, 151.5, 156.7, 167.8. Elemental analysis for C₃₀H₄₅O₄NCl₂: values in percentage calculated C 64.96, H 8.19, N 2.53; measured values: C 65.12, H 8.38, N 2.41. DSC determined glass transition temperature equal to the −18° C. TGA method: Tₒₙₛₑₜ 5%=177° C.; Tₒₙₛₑₜ=236° C.

Example IV. 1-Dodecylopyridinium 3,6-dichloro-2-methoxybenzoate A suspension of 0.02 mol of 3,6-dichloro-2-methoxybenzoic in 20 mL of distilled water was prepared in a round-bottom flask (100 mL) fitted with a magnetic stirrer. The temperature of the suspension was 60° C. Then aqueous KOH was added. After solution became homogenous, 0.02 mol of 1-dodecylpyridinium chloride in 20 mL of water was added to the reaction mixture. The reaction was carried out at room temperature for 24 hours. The mixture-based reaction product was extracted with ethyl acetate. The organic layer was washed several times with distilled water until disappearance of chloride ions in the leachate, the solvent was evaporated on a rotary evaporator, and the resulting product was dried under reduced pressure at 60° C. The product was obtained as a brown viscous liquid with yield of 91% and 99% purity. Nuclear magnetic resonance: ¹H NMR (CDCl₃) δ ppm=0.87 (t, J=6.7 Hz, 3H), 1.24 (m, 18H), 1.94 (q, J=6.6 Hz, 2H), 3.91 (s, 3H), 4.82 (t, J=7.4 Hz, 2H), 6.98 (d, J=8.8 Hz, 1H), 7.21 (d, J=8.5 Hz, 1H), 8.10 (t, J=7.0 Hz, 2H), 8.41 (t, J=7.7 Hz, 1H) , 9.46 (d, J=6.0 Hz, 2H), ¹³C NMR δ ppm=14.1, 22.6, 26.0, 29.0, 29.2, 29.3, 29.4; 29.5, 31.8, 31.9, 61.7, 61.9, 125.3, 125.9, 127.9, 128.2, 138.3, 144.4, 145.2, 151, 7, 168.1. Elemental analysis for C₂₅H₃₅O₃NCl₂ values calculated in percent: C 64.09, H 7.54, N 2.99; measured values: C 64.28, H 7.42, N 3.89. Using the techniques of DSC determined glass transition to be −2° C. TGA method: Tₒₙₛₑₜ 5%=187° C.; Tₒₙₛₑₜ=221° C., 355° C.

Example V. 1-Methyl-3-octyloxymethylitnidazolium 3,6-dichloro-2-methoxybenzoate A suspension of 0.025 mol of 3,6-dichloro-2-methoxybenzoic in 30 mL of distilled water was prepared in a round-bottom flask (100 mL) fitted with a magnetic stirrer. Then aqueous KOH was added and the reaction was vigorously stirred and heated at 50° C. for 20 minutes. After the solution became homogenous, a stoichiometric amount of 1-methyl-3-octyloxymethylimidazolium chloride was added in 10 mL of water. The mixture was vigorously stirred for 24 hours. Then chloroform was added to the system and the organic layer was washed with distilled water until the disappearance of chloride ions in the effluent. In the final stage of the chloroform was removed in the evaporator and the product dried at 70° C. under reduced pressure. Yield 74%. The structure was confirmed by NMR and elemental analysis. ¹H NMR (CDCl3) δ ppm=0.87 (t, J=6.7 Hz, 3H), 1.23 (m, 10H), 1.51 (q, J=6.3 Hz, 2H), 3.48 (t, J=6.5 Hz, 2H), 3.91 (s, 3H), 4.03 (s, 3H), 5.64 (s, 2H), 6.99 (d, J=8.5 Hz, 1H), 7.07 (d, J=8.5 Hz, 1H), 7.40 (t, J=2 Hz, 1H), 7.46 (t, J=2 Hz, 1H), 10.37 (s, 1H) ¹³C NMR δ ppm=14.1, 22.6, 25.8, 29.2, 29.3, 29.4, 31.8, 36.4, 61, 7, 70.3, 79.0, 120.5, 123.7, 125.3, 125.9, 127.8, 127.9, 138.1, 138.6, 151.7, 168.6. Elemental analysis for C₂₁H₃₀O₄N₂Cl₂: values in percentage calculated C 56.62, H 6.80, N 6.29; measured values: C 56.18, H 6.15, N 6.23.

Example VI. Alkyldipolyoxyethylene (15)-methylammonium 3,6-dichloro-2-methoxybenzoate Equimolar amounts of 3,6-dichloro-2-methoxybenzoate alkyldipolyoxyethylene(15)-methylammonium chloride (alkyl represents hydrogenated tallow) and sodium 3,6-dichloro-2-methoxybenzoate were placed into the reaction flask. The mixture was dissolved in water and vigorously stirred. Then the product was extracted with ethyl acetate and the organic layer was washed with distilled water. The presence of chloride ions in the effluent was monitored using AgNO₃. The chloroform was then evaporated on a rotary evaporator. The product was obtained as an orange liquid in 89% yield. The product was dried under vacuum at elevated temperatures. ¹H NMR (CDCl₃) δ ppm=0.88 (t, J=6.7 Hz, 3H), 1.26 (m, 28H), 1.71 (m, 2H), 3.29 (s, 3H) , 3.38 (s, 3H), 3.62 (t, J=6.6 Hz, 2H), 3.64 (m, 44H), 3.65 (m, 8H), 3.95 (m, 8H), 6.97 (d, J=8.5 Hz, 1H), 7.07 (d, J=8.5 Hz, 1H) ¹³C NMR δ ppm=14.1, 22.6, 26, 3, 29.2, 29.3, 29.50, 29.59, 29.64, 31.8, 49.2, 61.4, 61.6, 63.8, 64.8, 70.1; 70.4, 72.5, 125.1, 125.8, 127.1, 127.8, 139.6, 151.6, 168.2. On the DSC curves, a clear deviation was observed from the baseline accompanied by a small endothermic peak at a temperature of −57 ° C., which indicated a glass transition temperature and a clear sharp endothermic peak at a temperature of -36° C., which indicated the melting temperature of the IL. TGA method specified thermal stability Tₒₙₛₑₜ 5%=170° C.; Tₒₙₛₑₜ=200° C., 322° C., 387° C.

Example VII. Tetrabutylphosphonium 3,6-dichloro-2-methoxybenzoate Equimolar aqueous solutions of tetrabutylphosphonium chloride and sodium 3,6-dichloro-2-methoxybenzoate were mixed together. After 24 hours, the product was extracted with the chloroform. The chloroform layer was washed several times with water until the disappearance of chloride anions in the leachate. The organic layer was evaporated on a rotary evaporator. The product was then dried at a temperature of 60° C. under reduced pressure to obtain an orange slimy substance in 51% yield. ¹H NMR (CDCl₃) δ ppm=0.94 (t, J=6.9 Hz, 12H), 1.47 (m, 16H), 2.34 (m, 8H) , 3.98 (s, 3H), 6.95 (d, J=8.5 Hz, 1H), 7.04 (d, J=8.5 Hz, 1H) ¹³C NMR δ=13.3 ppm , 18.4 (d, JCP=47.4 Hz), 23.6 (d, JCP=4.9 Hz), 23.9, 61.3, 124.8, 125.5, 126.4, 127. 8, 140.2, 151.4, 167.3. Elemental analysis for C₂₄H₄₁O₃PCl₂: calculated C 60.11, H 8.64; measured C 60.25, H 8.52. DSC T glass 6° C., TGA : Tₒₙₛₑₜ 5%=180° C.; Tₒₙₛₑₜ=232° C., 355° C.

Example VIII. 1-Butyl-1-methylmorpholinium 3,6-dichloro-2-methoxybenzoate A solution of 0.01 mol of sodium 3,6-dichloro-2-methoxybenzoate in distilled water was placed into a round-bottomed flask (100 mL) fitted with a magnetic stirrer. The flask was placed into darkness and 0.011 mol of Ag nitrate (aqueous solution) was added. After 5 minutes, the silver salt was filtered and washed several times with distilled water. Then, the suspension of silver 3,6-dichloro-2-methoxybenzoate silver in 50 mL of distilled water was mixed with the aqueous solution of 0.009 mol of 1-butyl-1-methylmorpholinium bromide. After 24 hours of vigorous stirring, the precipitate was filtered under vacuum and the filtrate evaporated under reduced pressure. Finally, the product was dried under vacuum. A yellow compound (glass) was obtained in 99% yield. Nuclear magnetic resonance and elemental analysis (CHN): ¹H NMR (DMSO-d6) δ ppm=0.92 (t, J=7.3 Hz, 3H), 1.29 (sex, J=7.4 Hz, 2H), 1.65 (q, J=4.0 Hz, 2H), 3.15 (s, 3H), 3.43 (t, J=7.1 Hz, 4H), 3.71 (t, J=4.4 Hz, 2H), 3 , 80 (s, 3H), 3.91 (t, J=4.9 Hz, 4H), 7.06 (d, J=8.4 Hz, 1H), 7.20 (d, J=8, 4 Hz, 1H) ¹³C NMR δ ppm=13.6, 19.2, 22.8, 45.8, 58.9, 59.9, 61.0, 63.6, 125.0, 125.2 , 126.7, 127.4, 140.2, 151.0, 165.1. Elemental analysis for C₁₇H₂₅O₄NCl₂: calculated values: C 53.97, H 6.67, N 3.70; measured values: C 53.62, H 6.44, N 3.85. The analysis of DSC determined glass transition temperature: −16° C. TGA method specified thermal stability Tₒₙₛₑₜ 5%=187° C.; Tₒₙₛₑₜ=215° C.

Example IX. Alkyldi(2-hydroxyethyl)methylammonium 3,6-dichloro-2-methoxybenzoate Equimolar aqueous solutions of 76% alkyldi-(2-hydroxyethyl) methylammonium chloride (as coco alkyl) and sodium3,6-dichloro-2-methoxybenzoate sodium were mixed together. The reaction mixture was stirred vigorously. Then the product was extracted with chloroform and the organic layer was washed with distilled water. The presence of chloride anions in the effluent was monitored by silver nitrate test. In the final stage, the chloroform was evaporated on a rotary evaporator. The product in the form of orange slime was obtained in 99% yield. It was additionally dried at atmospheric pressure at a temperature of 100° C. NMR analysis: ¹H NMR (CDCl₃) δ ppm=0.88 (t, J=6.6 Hz, 3H), 1.26 (m, 20H), 1.61 (q, J=7.3 Hz, 2H), 3.19 (s, 3H), 3.37 (t, J=8.0 Hz, 2H), 3.58 (t, J=4.0 Hz, 4H), 3.91 (s, 3H), 3.99 (t, J=4.0 Hz, 4H), 7.01 (d, J=8.5 Hz, 1H), 7.13 (d, J=8.5 Hz , 1H) 13C NMR δ ppm=14.1, 22.4, 22.5, 22.6, 26.3, 29.2, 29.3, 29.5, 29.6, 31.8, 50, 0, 55.6, 61.7, 63.6, 64.1, 125.4, 126.0, 127.5, 127.9, 138.5, 151.6, 168.9. The analysis examined the DSC glass transition temperature of the ion pair to be −12° C.

Example X. Alkyltrimethylammonium 3,6-dichloro-2-methoxybenzoate—[ATMA] [Dicamba] A suspension of 3,6-dichloro-2-methoxybenzoic acid in deionized water was prepared in the reaction flask (100 mL). The flask was fitted with a magnetic stirrer, a reflux condenser, and a heating bath. An aqueous solution of NaOH (10% molar excess) was added to the suspension at 50° C. Alkyltrimethylammonium chloride (including a coco alkyl) was then added at room temperature. After 18 hours of stirring, the product was extracted with chloroform. The organic layer was washed several times with deionized water until disappearance of chloride ions in the leachate, and then the solvent was evaporated on a rotary evaporator. The resulting product was dried under reduced pressure at 50° C. The product was obtained in the form of cream slime performance in 70% yield and 99% purity. ¹H NMR (CDCl₃) δ ppm=0.88 (t, J=6.7 Hz, 3H), 1.26 (m, 20H), 1.60 (q, J=7.3 Hz, 2H), 3, 27 (s 9H), 3.30 (t, J=8.5 Hz, 2H), 3.91 (s, 3H), 6.97 (d, J=8.5 Hz, 1H), 7 , 08 (d, J=8.5 Hz, 1H) 13C NMR δ ppm=14.1, 22.7, 23.1, 26.2, 29.25, 29.32, 29.4, 29, 5, 29.6, 31.9, 53.1, 61.7, 66.5, 125.3, 126.0, 127.4, 127.6, 139.6, 151.6, 168.1.

Example XI. Di(hydrogenated tallow) dimethylammonium 3,6-dichloro-2-methoxybenzoate Di(hydrogenated tallow)dimethylammonium chloride (0.01 mol) was dissolved in 60 mL of distilled water by gentle heating and stirring. Sodium 3,6-dichloro-2-methoxybenzoate (0.01 mol) was dissolved in 60 mL of distilled water. The two solutions were combined and the reaction mixture was heated and stirred for 3 hours. The mixture was cooled down to room temperature and 40 mL of chloroform was added. The chloroform phase was washed with fresh distilled water until all chloride ions were washed out. The reaction progress was monitored by using water solution of AgNO₃. The chloroform was distilled off and the product dried at 70° C. in vacuum. [Arquad 2HT][Dicamba] ¹H NMR (CDCl₃) δ ppm=0.88 (t, J=6.7 Hz, 6H), 1.26 (m, 49H), 1.61 (q, J=6.8 Hz, 4H), 3.31 (s, 6H), 3.35 (t, J=6.3 Hz, 4H), 3.93 (s, 3H), 6.98 (d, J=8.5 Hz, 1H), 7.10 (d, J=8.5 Hz, 1H); ¹³C NMR δ ppm=14.0, 22.5, 26.1, 29.1, 29.25, 29.29, 29.37, 29.50, 29.55, 29.59, 31.8, 51.03, 61.6, 63.2, 125.3, 126.0, 127.6, 128.0, 139.1, 51.99, 168.0.

Example XII. Soyatrimethylammonium 3,6-dichloro-2-methoxybenzoate 0.015 mol of soyatrimethylammonium chloride, 0.015 mol of 3,6-dichloro-2-methoxybenzoic acid, 0.015 NaOH, and 150 mL of distilled water were charged to a round bottomed flask with a magnetic strir bar. The reaction mixture was stirred and heated at 50° C. for 1 h. After cooling, the mixture was extracted by chloroform. The organic layer was then washed three times with distilled water. The aqueous phases were tested for the presence of chloride ion using silver nitrate solution. Chloroform was removed and product was dried in vacuum. [ARQUAD SV][Dicamba] ¹H NMR (CDCl₃) δ ppm=0.88 (t, J=6.6 Hz, 3H), 1.26 (m, 24H), 1.59 (q, J=7.3 Hz, 2H), 2.02 (m, 3H), 3.22 (s, 9H), 3.28 (t, J=8.5 Hz, 2H), 3.88 (s, 3H), 5.39 (m 2H), 6.98 (d, J=8.6 Hz, 1H), 7.11 (d, J=8.6 Hz, 1H); ¹³C NMR δ ppm=14.0, 18.9, 22.5, 22.6, 23.0, 26.1, 27.1, 28.97, 29.12, 29.16, 29.23, 29.28, 29.38, 29.40, 29.45, 29.53, 29.58, 29.63, 31.81, 31.83, 32.50, 32.53, 35.58, 53.1, 61.8, 66.6, 125.5, 126.1, 127.8, 128.1, 129.9, 130.0, 130.2, 130.3, 130.4, 138.3, 151.9, 168.8.

Example XIII. Cocotrimethylammonium 3,6-dichloro-2-methoxybenzoate 0.030 mol of cocotrimethylammonium chloride, 0.030 mol of 3,6-dichloro-2-methoxybenzoic acid, 0.030 mol of NaOH, and 300 mL of distilled water were charged to a round bottomed flask with a magnetic strir bar. The reaction mixture was stirred and heated at 50° C. for 1 h. After cooling, the mixture was extracted with chloroform. The organic layer was then washed three times with distilled water. The aqueous phases were tested for the presence of chloride ion using silver nitrate solution. The chloroform was removed and the product was dried under vacuum.

Example XIV. Dialkyl dimethyl ester quaternary ammonium 3,6-dichloro-2-methoxybenzoate Dialkyl dimethyl ester quaternary ammonium chloride (0.01 mol), 0.01 mol of 3,6-dichloro-2-methoxybenzoic acid, 0.01 NaOH, and 100 mL of distilled water was stirred at 70 ° C. for 2 h. The aqueous solution was extracted by chloroform. Chloroform was removed and the product was dried in the presence of P₄O₁₀. [ARMOSOFT DEQ][Dicamba] ¹H NMR (CDCl₃) δ ppm=0.88 (t, J=6.6 Hz, 6H), 1.26 (m, 42H), 1.57 (q, J=6.9 Hz, 4H), 2.29 (m, 4H), 2.32 (t, J=9.3 Hz, 4H), 3.41 (s, 6H), 3.90 (s, 3H), 3.97 (t, J=4.6 Hz, 4H), 4.52 (t, J=4.6 Hz, 4H), 5.34 (m 2H), 7.00 (d, J=8.6 Hz, 1H), 7.12 (d, J=8.6 Hz, 1H); ¹³C NMR δ ppm=14.1, 22.6, 24.6, 27.1, 27.2, 28.9, 29.03, 29.08, 29.15, 29.25, 29.30, 29.45, 29.60, 29.65, 29.69, 31.83, 31.86, 33.9, 52.2, 57.6, 61.8, 63.5, 125.6, 126.2, 127.9, 128.2, 129.6, 130.0, 138.2, 151.9, 168.8, 172.7.

Example XV. Myristyltrimethylammonium 3,6-dichloro-2-methoxybenzoate Myristyltrimethylammonium bromide (0.02 mol; 7728 mg), 0.02 mol of 3,6-dichloro-2-methoxybenzoic acid (4420 mg), 0.02 NaOH (800 mg), and 200 mL of distilled water was stirred at 70° C. for 2 h. The aqueous solution was extracted by chloroform. Chloroform was removed under reduced pressure and the product was dried in vacuum. ¹H NMR (CDCl₃) δ ppm=0.88 (t, J=6.6 Hz, 6H), 1.26 (m, 42H), 1.57 (q, J=6.9 Hz, 4H), 2.29 (m, 4H), 2.32 (t, J=9.3 Hz, 4H), 3.41 (s, 6H), 3.90 (s, 3H), 3.97 (t, J=4.6 Hz, 4H), 4.52 (t, J=4.6 Hz, 4H), 5.34 (m 2H), 7.00 (d, J=8.6 Hz, 1H), 7.12 (d, J=8.6 Hz, 1H); ¹³C NMR (CDCl₃) δ ppm=14.1, 22.6, 24.6, 27.1, 27.2, 28.9, 29.03, 29.08, 29.15, 29.25, 29.30, 29.45, 29.60, 29.65, 29.69, 31.83, 31.86, 33.9, 52.2, 57.6, 61.8, 63.5, 125.6, 126.2, 127.9, 128.2, 129.6, 130.0, 138.2, 151.9, 168.8, 172.7; Water content: 5.4%; T_{5% dec}=161.5° C.; T_{50% dec}=206.7° C.

Example XVI. Dioctadecyldimethyllammonium 3,6-dichloro-2-methoxybenzoate The suspension of 3,6-dichloro-2-methoxybenzoic acid (0.02 mol, 4420 mg) in deionized water was prepared in the reaction flask (200 mL). The flask was fitted with a magnetic stirrer, a reflux condenser, and a heating bath. An aqueous solution of NaOH (10% molar excess) was added to the suspension at 50° C. (0.02 mol, 800 mg). Dioctadecyldimethylammonium chloride (0.02 mol, 11730 mg) was then added at room temperature. After 18 hours of stirring, the product was extracted with chloroform. The organic layer was washed several times with deionized water until disappearance of chloride ions in the leachate, and then the solvent was evaporated on a rotary evaporator. The resulting product was dried under reduced pressure at 50° C. The product was obtained in the form of cream slime performance in 70% yield and 99% purity.

Example XVII. 1-Hexadecylpyridinium 3,6-dichloro-2-methoxybenzoate 1-Hexadecylpyridinium chloride (0.02 mol, 7160 mg) was dissolved in water and then a stoichiometric amount of aqueous solution of 3,6-dichloro-2-methoxybenzoate potassium (0.02 mol) was added to form a homogeneous reaction mixture. The reaction was allowed to proceed for 24 hours and water was removed. Then, the anhydrous ethanol was added to precipitate the sodium chloride by-product, which was then filtered out. In the next stage, the filtrate was evaporated on a rotary evaporator and then the product was dried under reduced pressure. A yellow compound in the glassy state with 94% yield was obtained. ¹H NMR (d₆-DMSO) δ ppm=1.24 (s, 31H), 3.80 (s, 3H), 4.65 (t, 2H), 7.03 (d, J=8.7 Hz, 2H), 7.17 (d, J=8.7 Hz, 2H), 8.18 (dd, 2H), 8.62 (dd, 1H), 9.18 (d, 2H); Water content: 4.3%; T_{5% dec}=160.1° C.; T_{50% dec}278.6° C.

Example XVIII. Benzethonium 3,6-dichloro-2-methoxybenzoate The suspension of 3,6-dichloro-2-methoxybenzoic acid (0.02 mol, 4420 mg) in deionized water was prepared in the reaction flask (200 mL). The flask was fitted with a magnetic stirrer, a reflux condenser, and a heating bath. An aqueous solution of NaOH (10% molar excess) was added to the suspension at 50° C. (0.02 mol, 800 mg). Benzethonium chloride (0.02 mol, 8962 mg) was then added at room temperature. After 20 hours of stirring, the product was extracted with chloroform. The organic layer was washed several times with deionized water until disappearance of chloride ions in the leachate, and then the solvent was evaporated on a rotary evaporator. The resulting product was dried under reduced pressure at 50° C. The product was obtained in 75% yield and 99% purity. ¹H NMR (d₆-DMSO) δ ppm=0.67 (s, 9H), 1.29 (s, 6H), 1.68 (s, 2H), 3.05 (s, 6H), 3.59 (m, 2H), 3.80 (s, 3H), 3.83 (m, 2H), 4.01 (m, 2H), 4.12 (m, 2H), 4.67 (s, 2H), 6.83-6.84 (m, 2H), 7.03 (d, J=8.6Hz, 2H), 7.15 (d, J=8.6 Hz, 2H), 7.35-7.28 (m, 2H), 7.48-7.54 (m, 3H), 7.58-7.60 (m, 2H); Water content: 2.6%; T _{5% dec}=157.2° C.; T _{50% dec}=228.6° C.

Example XIX. Didodecyldimethylammonium 3,6-dichloro-2-methoxybenzoate The suspension of 3,6-dichloro-2-methoxybenzoic acid (0.02 mol, 4420 mg) in deionized water was prepared in the reaction flask (200 mL). The flask was fitted with a magnetic stirrer, a reflux condenser, and a heating bath. An aqueous solution of NaOH (10% molar excess) was added to the suspension at 50° C. (0.02 mol, 800 mg). Didodecyldimethylammonium chloride (0.02 mol, 8364 mg) was then added at room temperature. After 12 hours of stirring, the product was extracted with dichloromethane. The organic layer was washed several times with deionized water until the disappearance of chloride ions in the leachate, and then the solvent was evaporated on a rotary evaporator. The resulting product was dried under reduced pressure at 50° C. The product was obtained in 78% yield.

Example XX (2-Hydroxyethyl) trimethylammonium 3,6-dichloro-2-methoxybenzoate 3,6-Dichloro-2-methoxybenzoic acid (0.02 mol, 4420 mg) was added to a choline hydroxide 50% wt % solution in water (0.02 mol, 2424 active compound, 4884 g) at 50° C. After 12 hours of stirring, the water was removed. The resulting product was dried under reduced pressure at 50° C. The product was obtained in 90% yield and 99% purity. ¹H NMR (d₆-DMSO) δ ppm=3.12 (s, 9H), 3.42 (m, 2H), 3.80 (s, 3H), 3.85 (m, 2H), 7.05 (d, J=8.8 Hz, 2H), 7.17 (d, J=8.8 Hz, 2H).

Example XXL 4-Benzylmorpholinium 3,6-dichloro-2-methoxybenzoate The product was prepared from 4-benzylmorpholinium hydroxide and 3,6-dichloro-2-methoxybenzoic acid using the general procedure as described above. ¹H NMR (d₆-DMSO) δ ppm=3.33-3.35 (m, 2H), 3.53-3.57 (m, 2H), 3.79 (s, 3H), 3.95-3.97 (m, 4H), 4.74 (s, 2H), 7.08 (d, J=8.7 Hz, 1H), 7.23 (d, J=8.7 Hz, 1H), 7.50-7.59 (m, 5H).

Example XXII. 4-Benzyl-4-Hydroxymorpholinium 3,6-dichloro-2-methoxybenzoate The product was prepared from 4-benzyl-4-hydroxymorpholinium hydroxide and 3,6-dichloro-2-methoxybenzoic acid using the general procedure as described above. ¹H NMR (d₆-DMSO) δ ppm=3.46-3.57 (m, 4H), 3.80 (s, 3H), 3.98-4.02 (m, 4H), 4.86 (s, 2H), 7.09 (d, J=8.6 Hz, 1H), 7.24 (d, J=8.6 Hz, 1H), 7.50-7.54 (m, 3H), 7.60-7.62 (m, 2H).

Example XXIII. JEFFAMINE 3000 3,6-dichloro-2-methoxybenzoate A reaction flask fitted with a magnetic stirrer was charged with JEFFAMINE 3000 (Huntsman Corporation; The Woodlands, Tex.) and 3,6-dichloro-2-methoxybenzoic acid in a 1:1 molar ratio. The reaction mixture was heated with a heat gun for approximately 10 minutes (until all 3,6-dichloro-2-methoxybenzoic acid was dissolved) and stirred for another 2 hours at room temperature. A viscous brown liquid was obtained.

Example XXIV. JEFFAMINE 3000 di(3,6-dichloro-2-methoxybenzoate) A reaction flask fitted with a magnetic stirrer was charged with JEFFAMINE 3000 (Huntsman Corporation; The Woodlands, Tex.) and 3,6-dichloro-2-methoxybenzoic acid in a 1:2 molar ratio. The reaction mixture was heated with a heat gun for approximately 10 minutes (until all 3,6-dichloro-2-methoxybenzoic acid was dissolved) and stirred for another 2 hours at room temperature. A viscous brown liquid was obtained.

### B. Biological Testing

Experiment in growth chamber: Temperature—20° C., humidity—60%, photoperiod (day/night hours)—16/8. The research was conducted under controlled environmental conditions in a dedicated growth chamber. The test plants were white mustard (Sinapis alba) and common lambsquarters (Chenopodium album). The seeds were sown into soil-filled containers equal to the depth of 1 cm. After producing leaves, only 5 plants were allowed to stay in each pot. After producing the 3rd leaf, the plants were sprayed with the ionic liquids using a Tee Jet 1102 sprayer. The sprayer was moving above the plants at a constant speed of 3.1 m/s. The spray distance from the tips of the plant was 40 cm, the pressure of liquid in sprayer was 0.2 MPa, and the liquid in the expenditure per 1 ha was 200 L.

The plants were treated once with water/DMSO solution (2:1) of [DDA][Dicamba] of 0.001 mol/L (1 equiv., 0.546 g/L), 0.002 mol/L (2 equiv.,1.092 g/L), and 0.004 mol/L (4 equiv., 2.184 g/L) respectively, to determine absorption and phytotoxicity. Similarly, plants were treated with commercial Dicamba (BANVEL™) at the same acid equivalent concentrations. Water/DMSO solutions of BANVEL™ were prepared and contained 0.001 mol/L (1 equiv., 0.221 g/L), 0.002 mol/L (2 equiv., 0.442 g/L), and 0.004 mol/L (4 equiv., 0.884 g/L) of active component.

After spraying the plants, the pots were placed back in a growth chamber at a temperature of 20° C. (±2° C.) and humidity of 60%. The illumination time was 16 hours per day. The study was carried out in 4 replications in a completely randomized setup. After a period of 2 weeks, the plants were cut right to the soil level and weighed (0.1 g accuracy). The reduction of plant fresh weight as compared to control (no sprayed plants) was measured. Results of this study are shown in Table 2.

TABLE 2
Test results for [DDA][Dicamba] conducted on Sinapis alba L
and Chenopodium album under controlled environmental conditions.

| | | | Chenopodium |
|---|---|---|---|
| | Concentration | Sinapis alba^{b} | album^{b} |
| Treatments | (mole/L)^{a} | Fresh weight reduction (%) | |
| [DDA][Dicamba] | 0.001 | 6.8 | 16.7 |
| [DDA][Dicamba] | 0.002 | 18.5 | 41.7 |
| [DDA][Dicamba] | 0.004 | 27.1 | 45.7 |
| BANVEL ™^{c} | 0.001 | No reduction | 20.9 |
| BANVEL ™ | 0.002 | No reduction | 49.2 |
| BANVEL ™ | 0.004 | No reduction | 60.2 |

^{a}Other conditions included 2 weeks after treatment (2 WAT); temperature of 20° C. (±2° C), humidity 60%, illumination time 16/24;
^{b}Plants were grown at all otherwise identical conditions and differed in herbicidal treatment;
^{c}BANVEL ™ commercial herbicide containing active ingredient as an pure acid.

A preliminary comparison between the effect of [DDA][Dicamba] on the weight of Sinapis alba species was exceptional, indicating that [DDA] [Dicamba] was substantially more active than neutral Dicamba. The phytotoxicity of [DDA][Dicamba] to Sinapis alba increased with concentration from 0.001 to 0.004%. However, the phytotoxicity of [DDA][Dicamba] on another species, Chenopodium album, was similar to neutral Dicamba.

Field test. The research was conducted in the Field Experimental Station of the Institute of Plant Protection in Winna Gora on the plots of dimensions 1.5 m×5 m. The test plants were common lambsquarters (Chenopodium album) and cornflower (Centaurea cyanus). The investigated ion pairs were alkyltrimethylammonium 3,6-dichloro-2-methoxybenzoate ([ATMA][Dicamba]) and didecyldimethylammonium 3,6-dichloro-2-methoxybenzoate ([DDA][Dicamba]).

Solutions of investigated ion pairs were prepared as follows: alkyltrimethylammonium 3,6-dichloro-2-methoxybenzoate [ATMA][Dicamba] and didecyldimethylammonium 3,6-dichloro-2-methoxybenzoate [DDA][Dicamba] were dissolved in a mixture of water and ethanol (1:1) in an amount corresponding to a concentration of 0.01 and 0.02 mol/dm³. A comparative herbicide, a preparation containing 85% of 3,6-dichloro-2-methoxybenzoate, was dissolved in water (in accordance with the recommendations regarding the use of this measure) in an amount corresponding to 0.01 and 0.02 mol/dm³ of Dicamba. As controls, objects with no treatment were used and sprayed only with a solution of water and ethanol (1:1).

The procedures were performed using a sprayer equipped with a flat stream nozzles type Tee Jet 110 03 XR, with a steady pressure of 0.2 MPa and the expense of the liquid in use in 200 L per 1 hectare. During the procedure, the following weeds were at following developmental phases: common lambsquarters—from 4 to 10 leaves; and cornflower—a fully-formed rosette.

The effectiveness of weed eradication was evaluated visually by comparing the state of weeds on each plot treated with [DDA][Dicamba] and control solution. The evaluation took into account the following variables: the degree of soil coverage, the vigor of the weeds, and the height via mass. The effectiveness of the eradication of weeds was presented in percentage scale where 100% means the complete destruction and 0% means no action of the herbicide. Results of the efficiency of [DDA][Dicamba] and the neutral Dicamba are presented as the mean estimate of weed destruction as shown in Table 3. The results indicate that the susceptibility of species Chenopodium album and Centaurea cyanus in field conditions, where there is a competitive stress, are slightly different from that in the laboratory test, although [DDA] [Dicamba] was somewhat effective.

TABLE 3
Results of efficacy tests for [DDA][Dicamba] conducted on
Chenopodium album and Centaurea Cyanus species in the field

| | |
|---|---|
| Chenopodium album^{b} | Centaurea cyanus^{b} |

| | |
|---|---|
| Treatments^{a} | Effectiveness of Weed Eradication (%) |

| | | |
|---|---|---|
| [DDA][Dicamba] | 92% | 95% |
| BANVEL ™^{c} | 83% | 90% |

^{a}Conditions included 4 weeks after treatment (4 WAT);
^{b}Plants were grown at all otherwise identical conditions and differed in herbicidal treatment;
^{c}BANVEL ™ commercial herbicide containing active ingredient as an pure acid.

### Example 3

### Glyphosate Ionic Liquids

### A. Synthesis

Example I. 1,1-Dimethylpiperidinium Glyphosate 0.01 mol of 1,1-dimethylpiperidinium chloride was dissolved in 30 mL of distilled water and then passed through the ion exchange column (indicating Cl⁻ to OH⁻). The obtained solution was added to 0.011 mol of Glyphosate in 10 mL of distilled water. The reaction mixture was stirred for 30 min. The mixture was filtered and evaporated under reduced pressure to give final product. The obtained product was dried at 60° C. under reduced pressure. [Me₂Pip][Glyphosate] ¹H NMR (DMSO-d₆) δ ppm=1.52 (q, J=5.9 Hz, 2H), 1.78 (q, J=5.4 Hz, 4H), 2.86 (d, J=11.9 Hz, 2H), 3.08 (s, 6H), 3.32 (s, 2H), 3.34 (t, J=5.7 Hz, 4H), 4.76 (m, 3H); ¹³C NMR δ ppm=19.6, 20.6, 44.4, 46.2, 50.9, 61.6, 167.9. Anal. Calcd for C₁₀H₂₃O₅N₂P: C 42.54, H 8.23, N 9.92; Found: C 42.05, H 8.00, N 9.90.

Example II. (2-Chloroethyl)trimethylammonium Glyphosate 0.02 mol of (2-chloroethyl)trimethylammonium chloride was dissolved in 50 mL of distilled water and then passed through an ion exchange column (Amberlite OH form). To the obtained solution containing (2-chloroethyl)trimethylammonium hydroxide was added to stoichiometric amount of Glyphosate in 20 mL of distilled water. The reaction mixture was stirred for 30 minutes at room temperature. The water was evaporated under reduced pressure. The obtained product was dried at 70° C. under reduced pressure for 10 h. [CC][Glyphosate] ¹H NMR (D₂O) δ ppm=3.22 (s, 9H), 3.31 (d, J=11.9 Hz, 2H), 3.79 (t, J=7.0 Hz, 2H), 3.87 (s, 2H), 4.04 (t, J=7.0 Hz, 2H), 4.88 (m, 3H); ¹³C NMR δ ppm=38.5, 45.8, 47.6, 56.7, 69.1, 172.7. Anal. Calcd for C₈H₂₀O₅N₂ClP: C 33.05, H 6.95, N 9.64; Found: C 33.27, H 6.85, N 9.47.

Example III. Benzalkonium Glyphosate A single-necked round-bottomed flask with a magnetic stirring bar was charged with 10 g of benzalkonium hydroxide. A stoichiometric amount of Glyphosate was added and organic solvent. The mixture was stirred at room temperature for approximately 15 min. The organic solvent was removed using a rotary evaporator. [BA][Glyphosate] ¹H NMR (DMSO-d₆) δ ppm=0.85 (t, J=6.4 Hz, 3H), 1.25 (m, 20H), 1.77 (q, J=7.3 Hz, 2H), 2.86 (d, J=12.6 Hz, 2H), 2.98 (s, 6H), 3.24 (t, J=8.0 Hz, 2H), 3.31 (s, 2H), 4.57 (s, 2H), 4.92 (m, 3H), 7.50 (d, J=1.1 Hz, 2H), 7.56 (t, J=7.8 Hz, 1H), 7.59 (t, J=4.7 Hz, 2H); ¹³C NMR δ ppm=14.0, 21.8, 22.1, 25.9, 28.6, 28.8, 28.9, 29.0, 29.1, 31.3, 44.5, 46.3, 49.2, 63.2, 66.2, 128.3, 128.9, 130.2, 133.0, 167.8.

Example IV. Didecyldimethylammonium Glyphosate Didecyldimethylammonium bromide (0.01 mol) was dissolved in 50 mL of distilled water by gentle heating and stirring. After cooling, the reaction mixture was passed through the ion exchange column (indicating Br³¹ to OH⁻). To the obtained solution was added 0.012 mol of Glyphosate in 20 mL of distilled water. The reaction mixture was stirred at room temperature for 40 min. The mixture was filtered. A rotary evaporator was used to remove the water to obtain a wax dried at 60° C. under reduced pressure. [DDA][Glyphosate] ¹H NMR (DMSO-d₆) δ ppm=0.85 (t, J=6.7 Hz, 6H), 1.24 (m, 28H), 1.61 (q, J=7.3 Hz, 4H), 2.83 (d, J=12.4 Hz, 2H), 2.99 (s, 6H), 3.21 (t, J=8.3 Hz, 4H), 3.28 (s, 2H), 4.02 (m, 3H); ¹³C NMR δ ppm=14.1, 21.8, 22.3, 25.9, 28.7, 28.9, 29.0, 29.1, 31.5, 44.4, 46.2, 50.3, 62.9, 168.1. Anal. Calcd for C₂₅H₅₅O₅N₂P: C 60.68, H 11.23, N 5.66; Found: C 60.99, H 11.02, N 5.86.

Example V. Di(hydrogenated tallow) dimethylammonium Glyphosate A single-necked round-bottomed flask with a magnetic stirring bar was charged with 0.004 mol of Glyphosate and 40 ml, of distilled water. After 5 min, a water solution of NaOH (0.004 mol) was added dropwise and stirred over 10-15 min at room temperature. A stoichiometric amount of AgNO₃ was dissolved in distilled water. The two solutions were combined and the mixture was stirred for 20 min. The solid was filtered through a Buchner funnel and washed with distilled water. The resulting solid, di(hydrogenated tallow)dimethylammonium chloride (0.0038 mol) was dissolved in 50 mL of distilled water. The mixture was stirred for 24 h at room temperature. The obtained AgCl was fitered and water was removed using a rotary evaporator. The obtained product was dried at 60° C. under reduced pressure for 24 h. [Arquad 2HT][Glyphosate] ¹H NMR (CDCl₃) δ ppm=0.88 (t, J=6.8 Hz, 6H), 1.26 (m, 49H), 1.63 (q, J=7.2 Hz, 4H), 2.95 (d, J=11.9 Hz, 2H), 3.18 (s, 6H), 3.22 (t, J=8.2 Hz, 4H), 3.39 (s, 2H), 4.75 (m, 3H); ¹³C NMR δ ppm=14.1, 21.8, 22.4, 22.7, 26.1, 29.2, 29.3, 29.5, 29.7, 29.8, 31.9, 49.9, 50.9, 52.0, 63.5, 171.5.

Example VI. (Hydrogenated tallow)trimethylammonium Glyphosate A round-bottomed flask with a magnetic stirring bar was charged with 0.004 mol of (hydrogenated tallow)trimethylammonium chloride and 40 mL of distilled water. Then an aqueous solution of NaOH (0.004 mol) was added dropwise and stirred over 10-15 min at room temperature. AgNO₃ (0.004 mol) was dissolved in 20 mL of distilled water. The two solutions were combined and the mixture was stirring at room temperature for 20 min. The obtained solid AgCl was filtered and washed with distilled water. Then 0.004 mol of Glyphosate was added. The reaction mixture was stirred for 24 h at room temperature. Water was removed using a rotary evaporator. The obtained product was dried at 60° C. under reduced pressure for 24 h. ¹H NMR (D₂O) δ ppm=0.85 (t, J=6.7 Hz, 3H), 1.28 (m, 28H), 1.73 (q, J=7.3 Hz, 2H), 2.95 (d, J=11.7 Hz, 2H), 3.11 (s, 9H), 3.28 (t, J=8.4 Hz, 2H), 3.69 (s, 2H), 4.78 (m, 3H); ¹³C NMR δ ppm=15.8, 15.9, 24.56, 24.69, 28.2, 31.2, 31.3, 31.6, 31.7, 31.8, 31.9, 32.1, 32.2, 34.0, 46.8, 48.5, 54.9, 68.4, 173.4.

Example VII. 1-Butyl-1-methylpyrrolidinium Glyphosate 1-Butyl-1-methylpyrrolidinium chloride (0.01 mol) was dissolved in 50 mL of distilled water and passed through an ion exchange column (Amberlite OH form to exchange chloride with OH⁻). Then 0.01 mol of Glyphosate was added. The reaction mixture was stirred at room temperature for 10 min. A rotary evaporator was used to remove water. The product was dried at 70° C. under reduced pressure. [BuMePyr][Glyphosate] ¹H NMR (D₂O) δ ppm=0.94 (t, J=7.4 Hz, 3H), 1.37 (sex, J=7.4 Hz, 2H), 1.76 (q, J=4.1 Hz, 2H), 2.19 (q, J=3.6 Hz, 2H), 3.02 (s, 3H), 3.21 (d, J=12.5 Hz, 2H), 3.31 (t, J=8.5 Hz, 2H), 3.48 (t, J=7.7 Hz, 2H), 3.73 (s, 2H), 4.87 (s, 3H); ¹³C NMR δ ppm=15.3, 21.7, 23.7, 27.5, 45.5, 47.4, 50.4, 52.86, 52.95, 66.61, 66.65, 173.3.

Example VIII. Diallyldimethylammonium Glyphosate Diallyldimethylammonium chloride in water solution was passed through Amberlite (OH form). To the obtained diallyldimethylammonium hydroxide was added Glyphosate in stoichiometric amount. Water was removed under reduced pressure. The obtained product was dried at 40° C. under reduced pressure. [DADMA][Glyphosate] ¹H NMR (D₂O) δ ppm=3.01 (s, 6H), 3.21 (d, J=12.8 Hz, 2H), 3.72 (s, 2H), 3.89 (d, J=7.4 Hz, 4H), 4.88 (s, 3H), 5.66 (m, 2H), 5.73 (m, 2H), 6.04 (m, 2H); ¹³C NMR δ ppm=46.0, 52.3 (t, J=4.3 Hz), 68.9 (t, J=3.1 Hz), 127.2, 131.9, 173.8.

Example IX. 1-Dodecylpyridinium Glyphosate 1-Dodecylpyridinium hydroxide and Glyphosate in 0.01 mol scale and 50 mL of distilled water was stirred at room temperature for 20 min. Water was removed under reduced pressure. The obtained product was dried at 65° C. under reduced pressure for 10 h. [12Py][Glyphosate] ¹H NMR (D₂O) δ ppm=0.83 (t, J=6.7 Hz, 3H), 1.23 (m, 16H), 1.39 (m, 2H), 2.09 (q, J=7.0 Hz, 2H), 3.31 (d, J=12.5 Hz, 2H), 3.83 (s, 2H), 4.77 (t, J=7.3 Hz, 2H), 4.94 (s, 3H), 8.25 (t, J=7.3 Hz, 2H), 8.73 (t, J=7.8 Hz, 1H), 9.00 (d, J=5.4 Hz, 2H); ¹³C NMR δ ppm=16.1, 24.8, 28.1, 31.3, 31.55, 31.61, 31.9, 33.4, 34.1, 45.4, 47.2, 64.2, 130.8, 146.5, 148.3, 173.3.

Example X. Choline Glyphosate A round-bottomed flask with a magnetic stirring bar was charged with 5 g of choline hydroxide. A stoichiometric amount of Glyphosate was added and 50 mL of distilled water. The mixture was stirred at room temperature for approximately 10 min. Water was removed using a rotary evaporator. [Choline][Glyphosate] ¹H NMR (D₂O) δ ppm=3.19 (s, 9H), 3.23 (d, J=11.9 Hz, 2H), 3.51 (t, J=5.0 Hz, 2H), 3.73 (s, 2H), 4.04 (t, J=5.0 Hz, 2H), 4.88 (m, 3H); ¹³C NMR δ ppm=45.9, 47.8, 56.8 (t, J=4.0 Hz), 58.5, 70.3 (t, J=3.1 Hz), 173.9.

Example XI. 1-Ethyl-3-methylitnidazolium Glyphosate 1-Ethyl-3-methylimidazolium chloride (0.01 mol) was dissolved in 40 mL of distilled water and passed through an ion exchange column (Amberlite OH form to exchange chloride by OH⁻). Then 0.01 mol of

Glyphosate was added. The reaction mixture was stirred at room temperature for 15 min. A rotary evaporator was used to remove water. The obtained product was dried at 70° C. under reduced pressure for 12 h. [EMIm][Glyphosate] ¹H NMR (D₂O) δ ppm=1.50 (t, J=7.4 Hz, 3H), 3.31 (d, J=12.8 Hz, 2H), 3.75 (s, 2H), 3.90 (s, 3H), 4.23 (kw, J=7.3 Hz, 2H), 4.90 (s, 3H), 7.43 (t, J=1.8 Hz, 1H), 7.50 (t, J=1.8 Hz, 1H), 8.73 (s, 1H); ¹³C NMR δ ppm=17.4, 38.5, 46.0, 47.7, 47.8, 124.8, 126.4, 138.5, 173.9.

Example XII. Tetrabutylphosphonium Glyphosate Tetrabutylphosphonium chloride (0.02 mol) was dissolved in 30 mL of distilled water and passed through an ion exchange column (indicating Cl⁻ to OH⁻). To the obtained solution was added 0.022 mol of Glyphosate in 40 mL of distilled water. The reaction mixture was stirred at room temperature for 35 min. The mixture was filtered. A rotary evaporator was used to remove water and obtain the product which was dried at 60° C. under reduced pressure for overnight. [(C₄H₉)₄P][Glyphosate] ¹H NMR (D₂O) δ ppm=0.91 (t, J=7.1 Hz, 12H), 1.46 (m, 16H), 2.14 (m, 8H), 3.19 (d, J=12.8 Hz, 2H), 3.71 (s, 2H), 4.84 (s, 3H); ¹³C NMR δ ppm=15.4, 20.4 (d, J^{CP}=48.2 Hz), 25.5 (d, J^{CP}=4.5 Hz), 26.1, (d, J^{CP}=15.2 Hz), 46.0, 47.8, 173.8.

Example XIII. Tetrabutylammonium Glyphosate A single-necked round-bottomed flask with a magnetic stirring bar was charged with 15 g of tetrabutylammonium hydroxide. A stoichiometric amount of Glyphosate was added followed by 50 mL of distilled water. The mixture was stirred at room temperature approximately 15 min. Water was removed using a rotary evaporator. [TBA][Glyphosate] ¹H NMR (D₂O) δ ppm=0.93 (t, J=7.4 Hz, 12H), 1.35 (sex, J=7.4 Hz, 8H), 1.63 (q, J=7.7 Hz, 8H), 3.18 (t, J=8.5 Hz, 8H), 3.21 (d, J=12.8 Hz, 2H), 3.73 (s, 2H), 4.84 (s, 3H); ¹³C NMR δ ppm=15.7, 22.0, 25.9, 45.9, 47.7, 60.9, 173.7.

Example XIV. 4-Butyl-4-methylmorpholinium Glyphosate 4-Butyl-4-methylmorpholinium chloride (0.01 mol) was dissolved in 50 mL of distilled water. After 5 minutes of stirring, the solution was passed through the ion exchange column (indicating Cl⁻ to OH⁻). To the obtained solution was added 0.012 mol of Glyphosate in 20 mL of distilled water. The reaction mixture was stirred at room temperature for 15 min. The mixture was filtered. A rotary evaporator was used to remove water and the obtained product was dried at 60° C. under reduced pressure for 8 h. [BuMeMor][Glyphosate] ¹H NMR (D₂O) δ ppm=0.95 (t, J=7.4 Hz, 3H), 1.39 (sex, J=7.5 Hz, 2H), 1.77 (q, J=4.2 Hz, 2H), 3.17 (s, 3H), 3.21 (d, J=7.1 Hz, 2H), 3.43 (t, J=5.8 Hz, 4H), 3.49 (t, J=5.7 Hz, 2H), 3.73 (s, 2H), 4.04 (t, J=4.7 Hz, 4H), 4.88 (m, 3H); ¹³C NMR δ ppm=15.6, 21.9, 25.7, 45.9, 47.7, 49.5, 62.3, 63.2, 67.8, 173.7.

Example XV. 4-Benzyl-4-methylmorpholinium Glyphosate 4-Benzyl-4-methylmorpholinium hydroxide was dissolved in distilled water and stoichiometric amount of Glyphosate was added. After 10 min of stirring at 50° C. the mixture was filtered. Water was evaporated and product was dried at 70° C. under reduced pressure for overnight. [BenzMeMor][Glyphosate] ¹H NMR (D₂O) δ ppm=3.14 (s, 3H), 3.23 (d, J=13.5 Hz, 2H) 3.44 (m, 2H), 3,65 (m, 2H), 3.74 (s, 2H), 4.09 (m, 4H), 4.65 (s, 2H), 4.90 (m, 3H), 7.57 (d, J=1.1 Hz, 2H), 7.58 (t, J=7.8 Hz, 1H), 7.61 (t, J=4.7 Hz, 2H); ¹³C NMR δ ppm=47.9, 48.6, 53.4, 61.9, 63.3, 72.3, 128.9, 132.1, 132.8, 136.0, 173.8.

Example XVI. 4-Benzyl-4-(2-hydroxyethyl)morpholinium Glyphosate Into a round bottom flask equipped with a magnetic stirrer was added 0.01 mol of 4-benzyl-4-(2-hydroxyethyl)morpholinium hydroxide (obtained by ion exchange from chloride) dissolved in distilled water. Then 0.01 mol of Glyphosate was added and the reaction mixture was stirred for 10 min at room temperature. Solution was filtered and water was evaporated on a rotary evaporator. The product was dried under reduced pressure at 60° C. [Benz(OHEt)Mor] [Glyphosate] ¹H NMR (D₂O) δ ppm=3.22 (d, J=12.6 Hz, 2H) 3.61 (m, 4H), 3,64 (m, 2H), 3.74 (s, 2H), 4.13 (t, J=4.4 Hz, 4H), 4.20 (t, J=4.6 Hz, 2H), 4.78 (s, 2H), 4.85 (m, 3H), 7.57 (d, J=1.1 Hz, 2H), 7.60 (t, J=7.8 Hz, 1H), 7.62 (t, J=4.7 Hz, 2H); ¹³C NMR δ ppm=46.1, 48.0, 53.5, 57.7, 60.2, 60.5, 63.3, 68.9, 128.9, 132.2, 133.8, 136.1, 173.9.

Example XVII. Tetraethylammonium Glyphosate A round-bottomed flask with a magnetic stirring bar was charged with 0.01 mol of tetraethylammonium chloride and 20 mL of distilled water. Then an aqueous solution of NaOH (0.011 mol) was added dropwise and stirred over 10-15 min at room temperature. AgNO₃ (0.01 mol) was dissolved in 20 mL of distilled water. The two solutions were combined and the mixture was stirring at 50° C. for 20 min. After cooling the obtained solid was filtered and washed with distilled water. Then 0.01 mol of Glyphosate was added. The reaction mixture was stirred for 14 h at room temperature. Water was removed using a rotary evaporator. The obtained product was dried at 60° C. under reduced pressure for 24 h. [(C₂H₅)₄N][Glyphosate] ¹H NMR (D₂O) δ ppm=1.25 (t, J=9.1 Hz, 12H), 3.22 (kw, J=7.0 Hz, 8H), 3.28 (d, J=12.8 Hz, 2H), 3.73 (s, 2H), 4.90 (s, 3H); ¹³C NMR δ ppm=9.4, 46.0, 47.8, 54.7, 173.6.

Example XVIII. 1-Ethyl-1-methylpiperidinium Glyphosate 1-Ethyl-1-methylpiperidinium chloride (0.01 mol) was dissolved in 50 mL of distilled water and passed through an ion exchange column (Amberlite OH form to exchange chloride with Off). Then 0.01 mol of Glyphosate was added. The reaction mixture was stirred at 40° C. for 10 min. A rotary evaporator was used to remove water. The product was dried at 80° C. under reduced pressure. [EtMePip][Glyphosate] ¹H NMR (D₂O) δ ppm=1.32 (t, J=6.6 Hz, 3H), 1.64 (q, J=9.4 Hz, 2H), 1.69 (q, J=6.7 Hz, 4H), 2.99 (s, 3H), 3.18 (d, J=12.4 Hz, 2H), 3.31 (d, J=5.6 Hz, 4H), 3.40 (kw, J=7.3 Hz, 2H), 3.72 (s, 2H), 4.85 (m, 3H); ¹³C NMR δ ppm=9.5, 22.3, 23.5, 46.7, 47.6, 49.8, 53.5, 63.4, 173.9.

Example XIX. 1-Ethylpyridinium Glyphosate A round bottomed flask was charged with 0.01 mol 1-ethylpyridinium hydroxide, 0.01 mol Glyphosate, and 50 mL of distilled water. The reaction mixture was stirred at room temperature for 20 min. The solvent was removed under reduced pressure and the obtained product was dried at 65° C. under reduced pressure for 10 h.

### B. Biological Testing

Experiment in growth chamber: Temperature—20° C., humidity—60%, photoperiod (day/night hours)—16/8. The research was conducted under controlled environmental conditions in a dedicated growth chamber. The test plant was common poppy (Papaver rhoeas). The seeds were sown into soil-filled containers equal to the depth of 0.1 cm. After producing leaves, only 1 plant was allowed to stay in each pot. After producing the rosette, the plants were sprayed with the ionic liquids using a sprayer with Tee Jet 1102 nozzles. The sprayer was moving above the plants at a constant speed of 3.1 m/s. The spray distance from the tips of the plant was 40 cm, the pressure of liquid in sprayer was 0.2 MPa, and the liquid in the expenditure per 1 ha was 200 L.

The ionic liquids were dissolved in water in an amount corresponding to a concentration of 0.01 mol/L or 4.94 g/L [DDA][Glyphosate], 4.88 g/L [BA][Glyphosate]. As a comparison, a commercial product ROUNDUP™ containing 360 g of Glyphosate in 1 L was used. After spraying the plants, the pots were placed back in a growth chamber at a temperature of 20° C. (±2° C.) and humidity of 60%. The illumination time was 16 hours per day.

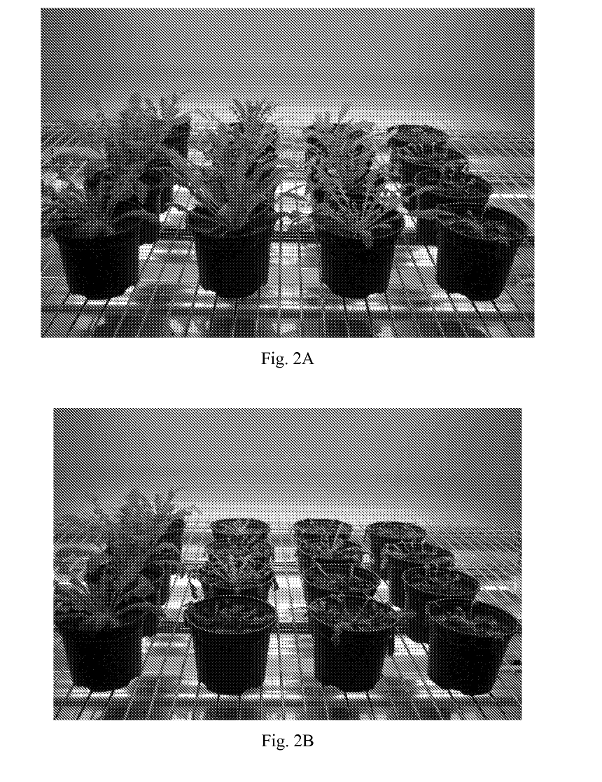

After a period of 2 weeks, the plants were cut right to the soil level and weighed (0.1 g accuracy). Fresh weight was used as the effect parameter. The reduction of plant fresh weight was compared to (i) control plants that were sprayed only with water and (ii) plants treated with commercial Glyphosate (ROUNDUP™). The study was carried out in 4 replications in a completely randomized setup. Results of this study are shown in Table 4 and FIG. 2.

TABLE 4
Test results for [DDA][Glyphosate] and [BA][Glyphosate] conducted
on Papaver rhoeas under controlled environmental conditions.

| | Concentration | Fresh weight reduction of |
|---|---|---|
| Treatments | (mol/L)^{a} | Papaver rhoeas^{b} (%) |
| [DDA][Glyphosate] | 0.01 | 78.3 |
| [BA][Glyphosate] | 0.01 | 84.0 |
| ROUNDUP ™^{c} | 0.01 | 88.1 |

^{a}Other conditions included 2 weeks after treatment (2 WAT); temperature of 20° C. (±2° C.), humidity 60%, illumination time 16/24;
^{b}Plants were grown at all otherwise identical conditions and differed in herbicidal treatment;
^{c}ROUNDUP ™ commercial herbicide containing Glyphosate as an isopropylammonium salt.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

1. A composition, comprising: at least one kind of cation, wherein the cation is not a protonated tertiary amine, a protonated heteroarylamine, a protonated pyrrolidine, or a metal, and wherein the cation has a bioactive property; and at least one herbicidal anion.

2. The composition of claim 1, wherein the cation and anion form an ion pair, an ionic liquid, are hydrogen bonded, form a complex, a eutectic, or a cocrystal.

3. The composition of claim 1, wherein the at least one herbicidal anion is selected from the group consisting of 3,6-dichloro-2-methoxybenzoate, 2-(4-chloro-2-methylphenoxy)propionate, or 2-((phosphonomethyl)amino)acetate.

4. The composition of claim 1, wherein the at least one kind of cation is selected from the group consisting of an herbicidal active, a pesticidal active, a nutritional active, an algaecidal active, an insecticidal active, a miticidal active, a molluscicidal active, a nematicidal active, a rodenticidal active, and a virucidal active.

5. The composition of claim 1, wherein the at least one kind of cation is a surfactant cation.

6. The composition of claim 1, wherein the at least one kind of cation is an antimicrobial cation or an antifungal cation.

7. The composition of claim 1, wherein the at least one kind of cation is a penetration enhancing cation.

8. The composition of claim 1, wherein the penetration enhancing cation is a fatty quaternary ammonium cation.

9. The composition of claim 1, wherein the at least one kind of cation is an ammonium cation of the structure ⁺NR¹R²R³R⁴, wherein R¹, R², R³, and R⁴ are each independently selected from hydrogen, substituted or unsubstituted C₁₋₂₀ alkyl, substituted or unsubstituted C₂₋₂₀ alkenyl, substituted or unsubstituted C₂₋₂₀ alkynyl, substituted or unsubstituted aryl, substituted or unsubstituted C₁₋₂₀ heteroalkyl, substituted or unsubstituted C₂₋₂₀ heteroalkenyl, substituted or unsubstituted C₂₋₂₀ heteroalkynyl, substituted or unsubstituted heteroaryl, or substituted or unsubstituted carbonyl.

10. The composition of claim 1, wherein one or more of R¹, R², R³, and R⁴ is methyl.

11. The composition of claim 1, wherein one or more of R¹, R², R³, and R⁴ is substituted or unsubstituted benzyl.

12. The composition of claim 1, wherein one or more of R¹, R², R³, and R⁴ is substituted or unsubstituted —(CH₂CH₂O)ₙ—, wherein n is an integer from 1 to 15.

13. The composition of claim 1, wherein one or more of R¹, R², R³, and R⁴ is ethyl phenyl ether.

14. The composition of any of claim 1, wherein one or more of R¹, R², R³, and R⁴ is substituted or unsubstituted allyl.

15. The composition of claim 1, wherein the composition comprises a substituted or unsubstituted ethyl ester.

16. The composition of claim 1, wherein the at least one kind of cation is a substituted or unsubstituted heteroaryl cation.

17. The composition of claim 1, wherein the heteroaryl cation is a substituted or unsubstituted pyridinium cation, a substituted or unsubstituted imidazolium cation, a substituted or unsubstituted morpholinium, a substituted or unsubstituted pyrrolidinium cation, a substituted or unsubstituted quinolinium cation, a substituted or unsubstituted isoquinolinium cation, or a substituted or unsubstituted nicotinamide cation.

18. The composition of claim 1, wherein the at least one kind of cation is a phosphonium cation of the structure ⁺PR¹R²R³R⁴, wherein R¹, R², R³, and R⁴ are each independently selected from hydrogen, substituted or unsubstituted C₁₋₂₀ alkyl, substituted or unsubstituted C₂₋₂₀ alkenyl, substituted or unsubstituted C₂₋₂₀ alkynyl, substituted or unsubstituted aryl, substituted or unsubstituted C₁₋₂₀ heteroalkyl, substituted or unsubstituted C₂₋₂₀ heteroalkenyl, substituted or unsubstituted C₂₋₂₀ heteroalkynyl, substituted or unsubstituted heteroaryl, or substituted or unsubstituted carbonyl.

19. The composition of claim 3, wherein 2-(4-chloro-2-methylphenoxy)propionate is (±)-2-(4-chloro-2-methylphenoxy)propionate.

20. The composition of claim 3, wherein 2-(4-chloro-2-methylphenoxy)propionate is (+)-(R)-2-(4-chloro-2-methylphenoxy)propionate.

21. The composition of claim 1, wherein the composition comprises one kind of cation.

22. The composition of claim 1, wherein the composition comprises one kind of cation and more than one anion selected from the group consisting of 3,6-dichloro-2-methoxybenzoate, 2-(4-chloro-2-methylphenoxy)propionate, or 2-((phosphonomethyl)amino)acetate.

23. The composition of claim 1, wherein the composition comprises more than one cation.

24. The composition of claim 1, wherein the composition comprises more than one kind of cation and more than one herbicidal anion selected from the group consisting of 3,6-dichloro-2-methoxybenzoate, 2-(4-chloro-2-methylphenoxy)propionate, or 2-((phosphonomethyl)amino)acetate.

25. The composition of claim 1, wherein the composition is an ionic liquid and is liquid at a temperature at or below about 125° C.

26. The composition of claim 1, wherein the composition is an ionic liquid and is liquid at a temperature at or below about 100° C.

27. The composition of claim 1, wherein the composition is an ionic liquid and is liquid at a temperature at or below about 75° C.

28. The composition of claim 1, wherein the composition is an ionic liquid and is liquid at a temperature at or below about 50° C.

29. The composition of claim 1, wherein the composition is an ionic liquid and is liquid at a temperature at or below about 25° C.

30. The composition of claim 1, wherein the composition is an ionic liquid and is liquid at a temperature from about −30° C. to about 150° C.

31. The composition of claim 1, wherein the composition is an ionic liquid and is liquid at a temperature from about 0° C. to about 120° C.

32. The composition of claim 1, wherein the composition is an ionic liquid and is liquid at a temperature of about 37° C.

33. The composition of claim 1, wherein the composition is liquid over a temperature range of at least 4 degrees.

34. The composition of claim 1, further comprising a preservative, dye, colorant, thickener, surfactant, a viscosity modifier, or a mixture thereof at less than about 10 wt % of the total ionic liquid composition.

35. The composition of claim 1, further comprising an herbicidal active, a pharmaceutical active, a fungicidal active, a nutraceutical active, a pesticidal active, or a food additive.

36. The composition of claim 1, further comprising a solvent.

37. A delivery device comprising the composition of claim 1.

38. A method of controlling plant growth in an area, comprising administering an effective amount of the composition of claim 1 to the area.

39. A method of preparing a composition, comprising:
combining at least one kind of cation or its precursor, wherein the cation is not a protonated tertiary amine, a protonated heteroarylamine, a protonated pyrrolidine, or a metal, and wherein the cation has a bioactive property; and at least one herbicidal anion or its precursor.

40. The method of claim 39, further comprising diluting the composition with a solvent.

41. The method of claim 39, wherein the at least one herbicidal anion is selected from the group consisting of 3,6-dichloro-2-methoxybenzoate, (±)-2-(4-chloro-2-methylphenoxy)propionate, or an anion of N-(phosphonomethyl) glycine.

42. The method of claim 39, wherein the at least one herbicidal anion precursor is selected from the group consisting of 3,6-dichloro-2-methoxybenzoic acid, (±)-2-(4-chloro-2-methylphenoxy)propionic acid, or N-(phosphonomethyl) glycine.

43. The method of claim 39, wherein combining the at least one kind of cation and the at least one anion is accomplished by a metathesis reaction.

44. The method of claim 39, wherein combining the at least one kind of cation precursor and the at least one anion precursor is accomplished by an acid-base neutralization reaction.

45. A method of selecting an ionic pair comprising a cation and an anion, comprising:
a. selecting a cation; and
b. selecting an anion,
wherein the cation or the anion is an herbicidal active; and wherein the cation and the anion are capable of forming an ionic liquid.

46. (canceled)

47. The method of claim 45, wherein
the cation is selected from the group consisting of a quaternary ammonium cation and a phosphonium cation; and
the anion is selected from the group consisting of 3,6-dichloro-2-methoxybenzoate, 2-(4-chloro-2-methylphenoxy)propionate, or 2-((phosphonomethyl)amino)acetate.

48. The method of claim 45, wherein the cation is selected from the group consisting of didecyldimethylammonium, benzalkonium, hexadecyltrimethylammonium, diallyldimethylammonium, trioctylmethylammonium, tetraoctylphsophonium, cocoalkyltrimethylammonium, dicocoalkyldimethylammonium, and cocoalkyldi-(2-hydroxyethyl)-methylammonium and the anion is 2-(4-chloro-2-methylphenoxy)propionate.

49. The method of claim 45, wherein the cation is selected from the group consisting of didecyldimethylammonium, benzalkonium, dodecyldimethylphenoxyethylammonium, tallowalkyldipolyoxyethylene(15)-methylammonium, tetrabutylphosphonium, cocoalkyldi-(2-hydroxyethyl)-methylammonium, cocoalkyltrimethylammonium, di(hydrogenated tallow)dimethylammonium, soyatrimethylammonium, cocotrimethylammonium, dicocoalkyldimethylammonium, myristyltrimethylammonium, dioctadecyldimethylammonium, didodecyldimethylammonium, and (2-hydroxyethyl)trimethylammonium and the anion is 3,6-dichloro-2-methoxybenzoate.

50. The method of claim 45, wherein the cation is (2-chloroethyl)trimethylammonium, benzalkonium, didecyldimethylammonium, di(hydrogenated tallow) dimethylammonium, (hydrogenated tallow)trimethylammonium, diallyldimethylammonium, choline, tetrabutylphosphonium, tetrabutylammonium, tetraethylammonium, and hexadecyltrimethylammonium and the anion is 2-((phosphonomethyl)amino)acetate.
